(19) United States
(12) Patent Application Publication
(10) Pub. No.: US 2025/0001259 A1
(43) Pub. Date: Jan. 2, 2025

(54) EXERCISE ASSISTANCE METHOD OF ASSISTING USER’S EXERCISE BASED ON GROUND INCLINATION, WEARABLE DEVICE AND ELECTRONIC DEVICE FOR PERFORMING THE SAME

(71) Applicant: Samsung Electronics Co., Ltd., Suwon-si (KR)

(72) Inventors: Jihye LEE, Suwon-si (KR); Hoon HAN, Suwon-si (KR); Hyunsu PARK, Suwon-si (KR)

(21) Appl. No.: 18/736,042

(22) Filed: Jun. 6, 2024

Related U.S. Application Data
(63) Continuation of application No. PCT/KR2024/006018, filed on May 3, 2024.

(30) Foreign Application Priority Data
Jun. 30, 2023 (KR) 10-2023-0085017

(51) Int. Cl. A63B 24/00; A63B 71/06

(52) U.S. Cl. CPC A63B 24/0062; A63B 24/0087; A63B 71/0622

(57) ABSTRACT

An exercise assistance method of assisting user's exercise based on ground inclination, a wearable device and an electronic device for performing the same are provided. The exercise assistance method may include determining ground inclination in a direction in which a wearable device worn by the user moves based on sensor data, determining whether a ground surface in the direction in which the wearable device moves is downward inclination or upward inclination based on the ground inclination, when the ground surface is the downward inclination or the upward inclination, determining target exercise speed to achieve a target exercise amount of an exercise program performed by the wearable device based on the ground inclination, and adjusting at least one of current target exercise speed set to the exercise program and current exercise intensity set to the exercise program based on the determined target exercise speed.

### CROSS-REFERENCE TO RELATED APPLICATIONS

This application is a continuation application of International Application No. PCT/KR2024/006018 designating the United States, filed on May 3, 2024, in the Korean Intellectual Property Receiving Office and claiming priority to Korean Patent Application No. 10-2023-0085017, filed on Jun. 30, 2023, in the Korean Intellectual Property Office, the entire disclosures of which are all incorporated herein by reference in their entireties for all purposes.

### BACKGROUND

### 1. Field

Example embodiments relate to an exercise assistance method of assisting exercise of a user based on inclination such as ground inclination, a wearable device and/or an electronic device for performing the same.

### 2. Description of Related Art

Typically, a walking assistance device may be equipment and/or a device for assisting a person to exercise, and/or for assisting patient who is not able to walk by themselves due to various diseases or accidents to perform walking exercise for rehabilitation, and/or equipment and/or a device used for exercise. As the number of aging individuals increases, a growing number of people experience inconvenience in walking or have difficulty walking normally due to malfunctioning joint issues, and there is increasing interest in walking assistance devices. A walking assistance device may be worn on a body of a user to assist the user with exercising and/or walking, such as by providing a desired or necessary muscular strength and/or to induce the user to walk in a normal walking pattern. The walking assistance device may perform a function to assist various leg exercises (e.g., power walking, jogging, stair climbing, lunge, stretching) of a user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an example embodiment, an exercise assistance method of assisting exercise of a user based on ground inclination may include determining ground inclination in a direction in which a wearable device worn by the user moves based on sensor data, determining whether a ground surface in the direction in which the wearable device moves is downward inclination or upward inclination based on the ground inclination, when the ground surface is the downward inclination or the upward inclination, determining target exercise speed to achieve a target exercise amount of an exercise program performed by the wearable device based on the ground inclination, and adjusting at least one of current target exercise speed set to the exercise program and current exercise intensity set to the exercise program based on the determined target exercise speed.

In an example embodiment, an electronic device may include at least one processor comprising processing circuitry, and a communication module, comprising communication circuitry, configured to communicate with a wearable device under control of the at least one processor, wherein the at least one processor is individually and/or collectively configured to: when the wearable device operates in an exercise mode for assisting exercise of a user, determine target exercise speed to achieve a target exercise amount of an exercise program performed by the wearable device based on ground inclination in a direction in which the wearable device moves, and adjust at least one of current target exercise speed of the wearable device and exercise intensity currently set to the wearable device based on the determined target exercise speed.

In an example embodiment, a wearable device may include a driving module, including a motor, configured to generate torque, a torque transmission frame configured to transmit the generated torque to a leg of a user, a thigh fastener connected, directly or indirectly, to the torque transmission frame and configured to connect the torque transmission frame to the leg of the user, and the at least one processor, wherein the at least one processor is individually and/or collectively configured to, when the wearable device operates in an exercise mode for assisting exercise of a user, determine target exercise speed to achieve a target exercise amount of an exercise program performed by the wearable device based on ground inclination in a direction in which the wearable device moves, and adjust at least one of current target exercise speed set to the exercise program and current exercise intensity set to the exercise program based on the determined target exercise speed.

Other features and aspects will be apparent from the following detailed description, the drawings, and the claims.

### BRIEF DESCRIPTION OF THE DRAWINGS

These and/or other aspects, features and advantages will be clarified and more easily understood from the following description of the illustrative example embodiments together with the accompanying drawings.

FIG. 1 is a diagram illustrating an overview of a wearable device worn on a body of a user according to an example embodiment.

FIG. 2 is a diagram illustrating an exercise assistance system including a wearable device and an electronic device according to an example embodiment.

FIG. 3 is a rear schematic diagram of a wearable device according to an example embodiment.

FIG. 4 is a left side view of a wearable device according to an example embodiment.

FIGS. 5A and 5B are diagrams illustrating a configuration of a control system of a wearable device, according to an example embodiment.

FIG. 6 is a diagram illustrating an interaction between a wearable device and an electronic device according to an example embodiment.

FIG. 7 is a diagram illustrating a configuration of an electronic device according to an example embodiment.

FIGS. 8 and 9 are flowcharts illustrating operations of an exercise assistance method of assisting exercise of a user based on ground inclination according to an example embodiment.

FIGS. 10A, 10B, and 10C are diagrams illustrating adjustment of target exercise speed and/or exercise intensity in different inclination sessions according to an example embodiment.

FIGS. 11A and 11B are diagrams illustrating adjustment of target exercise speed and/or exercise intensity in a stair session according to an example embodiment.

FIG. 12 is a diagram illustrating a user setting screen with respect to adjustment of target exercise speed based on detection of ground inclination according to an example embodiment.

FIGS. 13A and 13B are diagrams illustrating a guide screen displayed on a smartwatch based on an operation mode according to an example embodiment.

FIG. 14 is a diagram illustrating map data showing a session in which target exercise speed is adjusted based on ground inclination according to an example embodiment.

FIG. 15 is a diagram illustrating automatic adjustment of an exercise mode based on detection of a previous exercise path according to an example embodiment.

### DETAILED DESCRIPTION

The following detailed structural or functional description is provided as an example only and various alterations and modifications may be made to the examples. Accordingly, the embodiments are not construed as limited to the disclosure and should be understood to include all changes, equivalents, and replacements within the idea and the technical scope of the disclosure.

As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the examples with reference to the accompanying drawings, like reference numerals refer to like elements and a repeated description related thereto will be omitted.

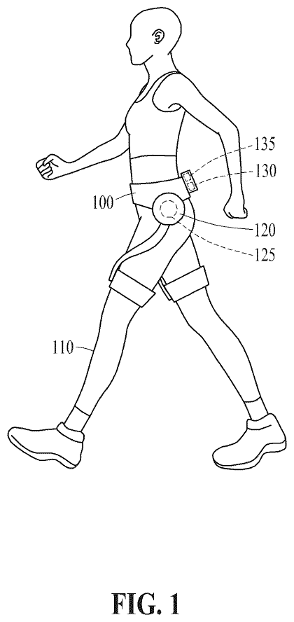

FIG. 1 is a diagram illustrating an overview of a wearable device worn on a user's body, according to an embodiment.

Referring to FIG. 1, in an embodiment, a wearable device 100 may be a device worn on a body of a user 110 to assist the user 110 in walking, exercising, and/or working. The wearable device 100 may be used to measure a physical ability (e.g., a walking ability, an exercise ability, or an exercise posture) of the user 110. In embodiments, the term “wearable device” may be replaced with “wearable robot,” “walking assistance device,” or “exercise assistance device”. The user 110 may be a human or an animal, but is not limited thereto. The wearable device 100 may be worn on the body (e.g., a lower body (legs, ankles, knees, etc.) or a waist) of the user 110 and may apply an external force, such as an assistance force and/or a resistance force, to a body motion of the user 110. The assistance force may be a force assisting the body motion of the user 110, which is applied in the same direction as a direction of the body motion of the user 110. The resistance force may be a force impeding the body motion of the user 110, which is applied in an opposite direction to the direction of the body motion of the user 110. The term “resistance force” may also be referred to as an “exercise load”.

In an embodiment, the wearable device 100 may operate in a walking assistance mode for assisting the user 110 in walking. In the walking assistance mode, the wearable device 100 may assist the walking of the user 110 by applying an assistance force generated through a driving module 120 of the wearable device 100 to the body of the user 110. The wearable device 100 may expand a walking ability of the user 110 by allowing the user 110 to walk independently or walk for a long time by providing a force needed for the walking of the user 110. The wearable device 100 may also improve the walking of a user having an abnormal walking habit or posture. Each “driving module” herein may include one or more of a motor, a sensor(s), and/or circuitry.

In an embodiment, the wearable device 100 may operate in an exercise assistance mode for enhancing the exercise effect of the user 110. The exercise assistance mode may include a resistance mode and an assistance mode. The resistance mode of the exercise assistance mode may represent a mode for hindering a body motion of the user 110 or providing resistance to a body motion of the user 110 by applying a resistance force generated by the driving module 120 to a body of the user 110. When the wearable device 100 is a hip-type wearable device that is worn on the waist (or pelvis) and legs (e.g., thighs) of the user 110, in the resistance mode, the wearable device 100 may provide an exercise load to a leg motion of the user 110 while being worn on the legs, thereby enhancing the exercise effect on the legs of the user 110. The assistance mode of the exercise assistance mode may be a mode for applying an assistance force for assisting exercise of the user 110 to the body of the user 110. In the assistance mode, an assistance force in the same direction as a body motion may be provided to the user 110 to assist the body motion of the user. For example, when a person with a disability or an elderly person wears the wearable device 100 to exercise, the wearable device 100 may provide an assistance force to assist a body motion. In the assistance mode, the wearable device 100 may provide a force in the same direction as a direction of a leg motion of the user 110 and the user 110 may improve a walking speed and a walking distance with a small force. In an exercise program, the resistance mode and the assistance mode may be combined and operated. For example, the wearable device 100 may provide a combination of an assistance force and a resistance force for each exercise session or time interval in such a manner of providing an assistance force in one exercise session and providing a resistance force in another exercise session. In the exercise assistance mode, various exercise programs may be operated depending on the exercise purpose or a physical ability of the user 110. The exercise program may include, for example, cardio, strength training, posture balancing, or any combination thereof. The resistance mode and the assistance mode may be alternately activated appropriately depending on an exercise program performed by the wearable device 100 and a target exercise speed that is suitable to an appropriate physical condition (e.g., a heart rate) of the user 110 may be guided to the user during the exercise of the user 110. For example, the target exercise speed may be provided in the unit of kilometers per hour (km/h), but the example is not limited thereto.

In an embodiment, the wearable device 100 may operate in a physical ability measurement mode for measuring a physical ability of the user 110. The wearable device 100 may measure motion information of the user 110 using a sensor (e.g., an angle sensor 125 and an inertial measurement unit (IMU) 135) provided in the wearable device 100 during the walking and/or exercise of the user 110 and may assess the physical ability of the user 110 based on the measured motion information. For example, a gait index or an exercise ability indicator (e.g., muscular strength, endurance, balance, or exercise motion) of the user 110 may be estimated through the motion information of the user 110 measured by the wearable device 100. The physical ability measurement mode may include an exercise posture measurement mode for measuring an exercise posture of the user 110.

In some embodiments, the description is provided based on an example in which the wearable device 100 is a hip-type wearable device as shown in FIG. 1. However, the embodiments are not limited thereto. As described above, the wearable device 100 may be worn on other body parts (e.g., upper arms, lower arms, hands, calves, or feet) other than the waist or legs (specifically, thighs). The shape and configuration of the wearable device 100 may vary depending on the body part on which the wearable device 100 is worn.

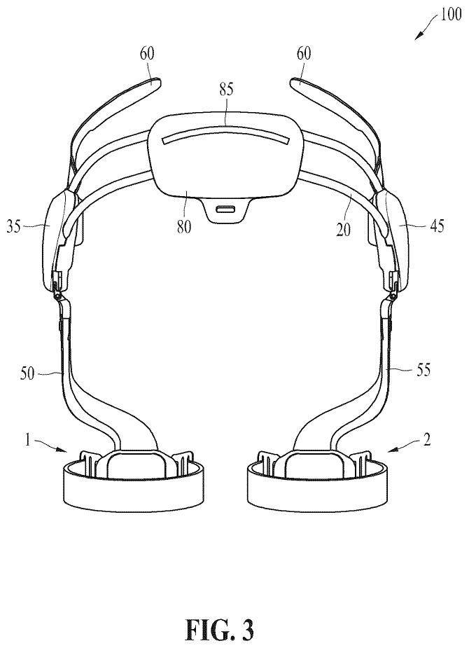

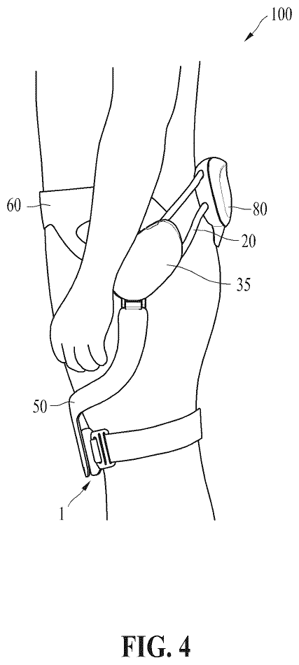

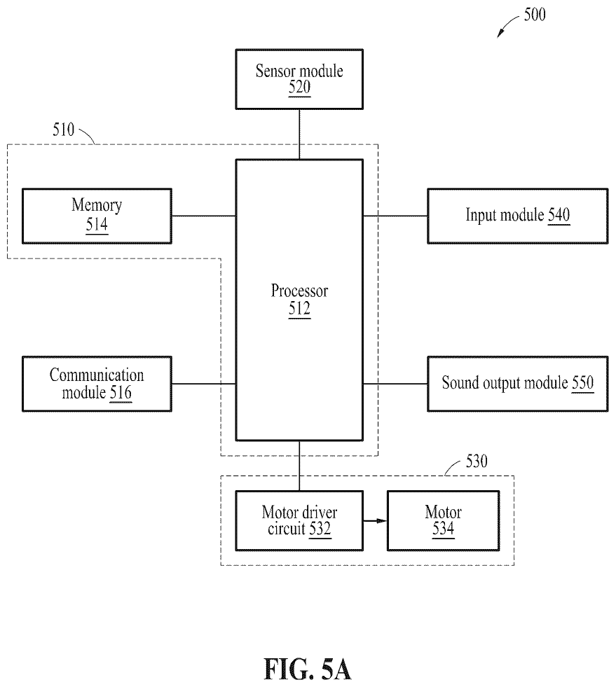

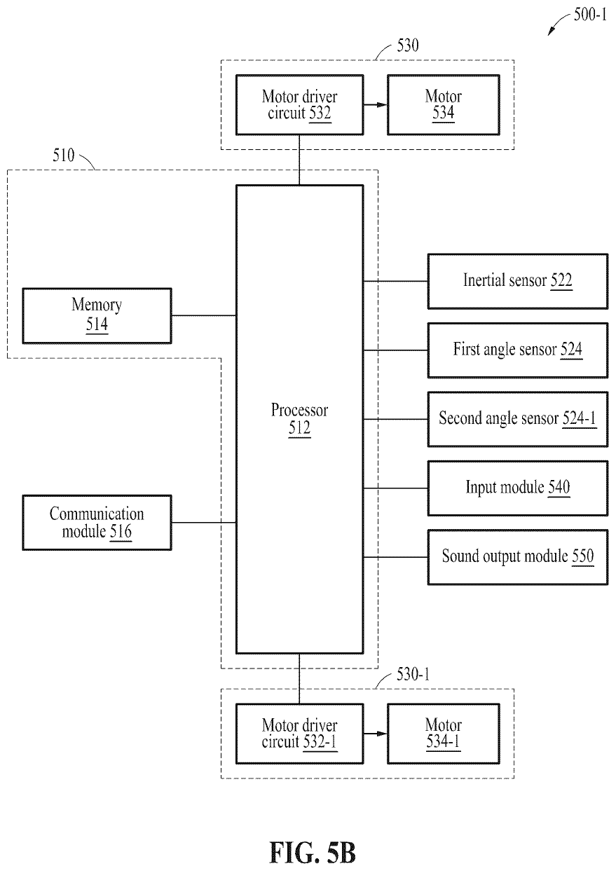

According to an embodiment, the wearable device 100 may include a support frame (e.g., a waist support frame 20 of FIGS. 3 and 4) for supporting the body of the user 110 when the wearable device 100 is worn on the body of the user 110, a driving module 120 (e.g., driving modules 35 and 45 of FIG. 3) configured to generate torque applied to legs of the user 110, a torque transmission frame (e.g., a first torque transmission frame 55 and a second torque transmission frame 50 of FIG. 3) configured to transmit torque generated by the driving module 120 to legs of the user 110, a sensor module (e.g., a sensor module 520 of FIG. 5A) including at least one sensor for obtaining sensor data including motion information about a body motion (e.g., a leg motion or an upper body motion) of the user 110, and a control module 130 (e.g., a control module 510 of FIGS. 5A and 5B, comprising processing circuitry) configured to control an operation of the wearable device 100.

The sensor module may include the angle sensor 125 and the IMU 135. The angle sensor 125 may measure a rotation angle of the torque transmission frame of the wearable device 100 corresponding to a hip joint angle value of the user 110. The rotation angle of the torque transmission frame measured by the angle sensor 125 may be estimated as a hip joint angle value (or a leg angle value) of the user 110. The angle sensor 125 may include, for example, an encoder and/or a hall sensor. In an embodiment, the angle sensor 125 may be disposed adjacent to a position where a motor included in the driving module 120 is connected, directly or indirectly, to the torque transmission frame. The IMU 135 may include an acceleration sensor and/or an angular velocity sensor, and may measure a change in acceleration and/or angular velocity according to a motion of the user 110. For example, the IMU 135 may measure a motion value of a waist support frame (e.g., the waist support frame 20 of FIG. 3) or a base body (e.g., a base body 80 of FIG. 3) of the wearable device 100. The motion value of the waist support frame or the base body measured by the IMU 135 may be estimated as a waist motion value or an upper body motion value of the user 110.

In an embodiment, the control module 130 and the IMU 135 may be disposed in the base body (e.g., the base body 80 of FIG. 3) of the wearable device 100. The base body may be on the waist of the user 110 when the user 110 wears the wearable device 100. The base body may be formed on or attached to the outside of the waist support frame of the wearable device 100.

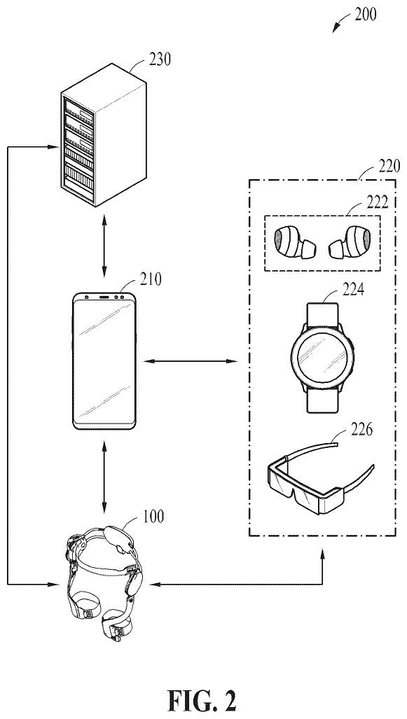

FIG. 2 is a diagram illustrating an exercise assistance system including a wearable device and an electronic device according to an embodiment.

Referring to FIG. 2, an exercise assistance system 200 may include the wearable device 100, an electronic device (or a user terminal) 210, another wearable device 220, and a server 230. In an embodiment, in the exercise assistance system 200, at least one of the devices described above (e.g., the another wearable device 220 or the server 230) or at least one device (e.g., a dedicated controller for the wearable device 100) may be added thereto.

In an embodiment, the wearable device 100 worn on a body of a user may assist the motion of the user in a walking assistance mode. For example, the wearable device 100 may be worn on the legs of the user to help the user in walking by generating an assistance force for assisting a leg motion of the user.

In an embodiment, the wearable device 100 may generate and apply a resistance force for hindering a body motion of the user and/or an assistance force for assisting a body motion of the user to the body of the user to enhance an effect of the user's exercise in the exercise assistance mode. In the exercise assistance mode, the user may select an exercise program (e.g., cardio such as power walking and outdoor walking, strength training such as squats, split lunges, dumbbell squats, and lunge and knee ups, a stretching exercise, a posture balancing exercise, or any combination thereof) that the user desires to conduct using the wearable device 100 through the electronic device 210 and/or exercise intensity applied to the exercise program. The wearable device 100 may control a driving module of the wearable device 100 based on the exercise program selected by the user and may obtain sensor data including motion information of the user through a sensor module. The wearable device 100 may adjust the strength of the resistance force and/or the assistance force applied to the user based on the exercise intensity selected by the user. For example, the wearable device 100 may control the driving module to generate a resistance force corresponding to the exercise intensity selected by the user. As the exercise intensity increases, the strength of the resistance force applied to the user may increase.

In an embodiment, the wearable device 100 may provide (or output) feedback (e.g., visual feedback, auditory feedback, or haptic feedback) corresponding to a state of the wearable device 100 in response to a control signal received from the electronic device 210. For example, the wearable device 100 may provide the visual feedback through a lighting unit (e.g., a lighting unit 85 of FIG. 3) and the auditory feedback through a sound output module (e.g., a sound output module 550 of FIGS. 5A and 5B).

The electronic device 210 may communicate with the wearable device 100, may remotely control the wearable device 100, or may provide the user with state information about a state (e.g., a booting state, a charging state, a sensing state, or an error state) of the wearable device 100. The electronic device 210 may recommend an exercise program using the wearable device 100 to the user and may analyze an exercise performed by the user. From the wearable device 100, the electronic device 210 may receive sensor data obtained by the sensor module of the wearable device 100 and may estimate a current exercise state, an exercise result, an exercise posture, and/or a physical ability of the user based on the received sensor data. The electronic device 210 may provide the user with the estimated exercise state, the exercise result, the exercise posture, and/or the physical ability of the user through a graphical user interface (GUI).

In an embodiment, the user may execute a program (e.g., an application) in the electronic device 210 to control the wearable device 100 and may adjust a torque magnitude output by a setting value (e.g., a driving module (e.g., the driving modules 35 and 45 of FIG. 3) or an operation of the wearable device 100, a sound volume of audio output from a sound output module (e.g., the sound output module 550 of FIGS. 5A and 5B), and a lighting unit (e.g., the brightness of the lighting unit 85 of FIG. 3)). The program executed by the electronic device 210 may provide a GUI for an interaction with the user. The electronic device 210 may be a device in various forms. For example, the electronic device 210 may include a portable communication device (e.g., a smartphone), a computer device, an access point, a portable multimedia device, or a home appliance (e.g., a television, an audio device, or a projector device), but examples are not limited to the foregoing devices.

In an embodiment, the electronic device 210 may be connected to the server 230 by using short-range wireless communication or cellular communication. The server 230 may receive user profile information of the user who uses the wearable device 100 from the electronic device 210 and may store and manage the received user profile information. The user profile information may include, for example, information about at least one of a name, an age, a gender, a height, a weight, medical history, or a body mass index (BMI). The server 230 may receive exercise history information about an exercise performed by the user from the electronic device 210 and may store and manage the received exercise history information. The server 230 may provide the electronic device 210 with various exercise programs or physical ability measurement programs to be provided to the user. In an embodiment, the server 230 may be connected, directly or indirectly, to the wearable device 100. The server 230 may receive, from the wearable device 100, the sensor data measured by the wearable device 100 and may transmit, to the wearable device 100, a control signal for controlling an operation of the wearable device 100 and/or data related to the exercise program. In an embodiment, the server 230 may be a cloud server.

According to an embodiment, the wearable device 100 and/or the electronic device 210 may be connected to the other wearable device 220. Exercise result information, physical ability information, and/or exercise posture assessment information of the user that are determined by the electronic device 210 may be transmitted to the other wearable device 220 and may be provided to the user through the other wearable device 220. The state information of the wearable device 100 may be transmitted to the other wearable device 220 and may be provided to the user through the other wearable device 220. In an embodiment, the wearable device 100, the electronic device 210, and the other wearable device 220 may be connected to each other via wireless communication (e.g., Bluetooth communication or wireless fidelity (Wi-Fi) communication). The other wearable device 220 may be, for example, wireless earphones 222, a smartwatch (or a watch-type wearable device) 224, or smartglasses (a wearable device in the type of glasses or goggles) 226, but is not limited to the devices described above.

In an embodiment, the wireless earphones 222 may be wirelessly connected to the electronic device 210 and/or the wearable device 100 and may output guide voice, music, and/or a sound effect related to the exercise program.

In an embodiment, the smartwatch 224 may include a heart rate sensor configured to measure a biosignal including heart rate information of a user and may transmit the biosignal measured by the heart rate sensor to the electronic device 210 and/or the wearable device 100. The electronic device 210 may estimate the heart rate information (e.g., the current heart rate, maximum heart rate, and average heart rate) of the user based on the biosignal received from the smartwatch 224 and provide the estimated heart rate information to the user. In an embodiment, the smartwatch 224 may include an inertial sensor configured to measure motion information of the user and/or a position sensor configured to measure position information of the user and may transmit the motion information and/or position information of the user to the electronic device 210 and/or the wearable device 100. The smartwatch 224 may include a communication module comprising communication circuitry (e.g., a short-range communication module) for communicating with another device (e.g., the electronic device 210 and the wearable device 100). In an embodiment, the smartwatch 224 may provide an interface related to an exercise program through a display. The interface related to the exercise program may be implemented by a separate application installed in the smartwatch 224.

In an embodiment, the smartglasses 226 may provide information to the user through a display in the form of glasses. For example, the smartglasses 226 may output information about, for example, current exercise speed, target exercise speed, ground inclination, a currently achieved exercise amount, and an exercise time through a display in the exercise mode. In addition, the smartglasses 226 may output a screen for guiding an exercise path to the user. The smartglasses 226 may include a vision sensor and may obtain topographic data indicating a topographic shape in a forward direction of the user through the vision sensor. The ground inclination in the forward direction of the user may be estimated by analyzing feature points of the topography in the obtained topographic data.

In an embodiment, the user may select an exercise program to perform from various exercise programs and may perform the selected exercise program. The exercise program performed by the user may include a target exercise amount to be achieved and target exercise speed with respect to each exercise session (e.g., an exercise concentration session and a recovery session) by considering the target exercise amount before the exercise begins. For example, the target exercise amount may be suggested as calories that the user desires to consume through the exercise or a total number of steps. During the exercise, the user may be provided with exercise coaching guide based on the target exercise speed set by the exercise program. For example, when the current exercise speed (e.g., walking speed) of the user is lower than the target exercise speed, guiding voice to walk faster may be provided to the user and when the current exercise speed is higher than the target exercise speed or a heart rate of the user is high, guiding voice to walk slower may be provided to the user.

The target exercise speed of each exercise session set by the exercise program selected by the user may not consider the ground inclination of the topography where the user actually performs the exercise. Depending on the ground inclination, an exercise amount to be achieved and exercise intensity may vary. Based on an assumption that the exercise is performed at the same exercise speed during the same time, as the ground inclination increases (in other words, the uphill ground inclination increases), the exercise amount to be achieved may increase. Since the ground inclination significantly affects the exercise amount as the exercise speed, it may be preferable to consider the ground inclination to accurately calculate the exercise amount that the user achieves through the exercise. Specifically, when the user wears the wearable device 100 and performs exercise, such as outdoor walking, running, and the like, the ground inclination may have a large proportion on an actual exercise amount.

To accurately manage an achievement state of an exercise amount during the exercise and reduce possibilities of imposing excessive burden on the body of the user and encountering a safety issue, it may be preferable to adjust the target exercise speed and/or the exercise intensity during the exercise by considering the ground inclination measured while the user performs the exercise. When the wearable device 100 operates in a resistance mode on an uphill road, if the ground inclination is not considered, the user may be easily exhausted because the user may exercise more than a planned exercise amount in the exercise program. When the wearable device 100 operates in an assistance mode on a downhill road, if the ground inclination is not considered, a safety accident, such as a fall, may occur because the user may exercise less than the planned exercise amount or exercise at inappropriately fast speed.

The wearable device 100 and/or the electronic device 210 may sense the ground inclination of a road on which the user currently walks and may adjust the target exercise speed and/or the exercise intensity to achieve the target exercise amount based on the ground inclination. The ground inclination may represent, for example, a tangent value of an angle (a degree) formed by the ground on which the user positions based on the ground plane as a percentage. In an embodiment, when it is expected that exercise amount achievement is different from exercise amount achievement that is planned by the exercise program due to the adjustment of the target exercise speed, the wearable device 100 and/or the electronic device 210 may adjust the exercise intensity for the user to achieve the planned exercise amount. Based on the adjustment of the exercise intensity, a magnitude of the strength provided by the wearable device 100 to the user may vary. In an embodiment, an exercise mode may change depending on the measured ground inclination. For example, when the high ground inclination is sensed, the exercise mode may be changed from a resistance mode to an assistance mode. The electronic device 210 may adjust the target exercise speed based on the ground inclination and the current exercise mode (or an exercise session). For example, when the current exercise mode is in the resistance mode and the downhill ground inclination is sensed, the target exercise speed may be changed to a value that is higher a previous value. When the current exercise mode is in the assistance mode and the downhill ground inclination is sensed, the target exercise speed may not be changed or may be changed to preset minimum speed for the safety. As described above, the efficiency, suitability, and safety of the exercise program may be improved by adjusting the target exercise speed and/or the exercise intensity of the user by considering the ground inclination and/or the exercise mode.

In an embodiment, when a ground inclination attribute (e.g., downward inclination, upward inclination, steep downward inclination, and stairs) is sensed based on the ground inclination, a guide notification of the ground inclination attribute may be provided to the user. In addition, when the target exercise speed and/or the exercise intensity is adjusted based on the ground inclination, a guide notification of the adjustment of the target exercise speed and/or the exercise intensity may be provided to the user. The guide notification may be provided to the user via a sound output module (e.g., the sound output module 550 of FIGS. 5A and 5B) of the wearable device 100 and another device (e.g., the electronic device 210, the wireless earphones 222, and the smartwatch 224) communicating with the wearable device 100.

FIG. 3 is a rear schematic diagram of a wearable device according to an embodiment. FIG. 4 is a left side view of a wearable device according to an embodiment.

Referring to FIGS. 3 and 4, the wearable device 100 in an embodiment may include a base body 80, a waist support frame 20, driving modules 35 and 45, torque transmission frames 50 and 55, thigh fasteners 1 and 2, and a waist fastener 60. The base body 80 may include a lighting unit 85. In an embodiment, at least one (e.g., the lighting unit 85) of the components described above may be omitted from the wearable device 100 or one or more other components may be added to the wearable device 100.

The base body 80 may be on the waist of a user when the user wears the wearable device 100. The base body 80 may be worn on the waist of the user to provide cushioning to the waist of the user and may support the waist of the user. The base body 80 may be hung on the hip part (an area of the hips) to prevent or reduce chances of the wearable device 100 from being downwardly separated due to gravity while the user wears the wearable device 100. The base body 80 may distribute a portion of the weight of the wearable device 100 to the waist of the user while the user wears the wearable device 100. The base body 80 may be connected, directly or indirectly, to the waist support frame 20. Waist support frame connecting elements (not shown) to be connected, directly or indirectly, to the waist support frame 20 may be provided at both ends of the base body 80.

In an embodiment, the lighting unit 85 may be provided on an outer surface of the base body 80. The lighting unit 85 may include a light source (e.g., a light-emitting diode (LED)). The lighting unit 85 may emit light in response to a control of a processor (not shown) (e.g., a processor 512 of FIGS. 5A and 5B) of the wearable device 100. In some embodiments, the lighting unit 85 may be controlled to provide (or output) visual feedback corresponding to the state of the wearable device 100 through the lighting unit 85.

The waist support frame 20 may support a body part (e.g., the waist) of the user when the wearable device 100 is worn on the body of the user. The waist support frame 20 may extend from both ends of the base body 80. The waist of the user may be accommodated inside the waist support frame 20. The waist support frame 20 may include at least one rigid body beam. Each beam may be in a curved shape having a preset curvature to enclose the waist of the user. The waist fastener 60 may be connected, directly or indirectly, to the end of the waist support frame 20. The driving modules 35 and 45 may be directly or indirectly connected to the waist support frame 20.

In an embodiment, a processor, a memory (e.g., a memory 514 of FIGS. 5A and 5B), an inertial sensor (e.g., the IMU 135 of FIG. 1 and an inertial sensor 522 of FIG. 5B), a communication module (e.g., a communication module 516 of FIGS. 5A and 5B), a sound output module (e.g., a sound output module 550 of FIGS. 5A and 5B), and a battery (not shown) may be disposed in the base body 80. The base body 80 may protect the components disposed therein. The processor may generate a control signal for controlling an operation of the wearable device 100. The processor may control a motor of the driving module 35 or 45. The processor and the memory may be included in a control circuit. The control circuit may further include a power supply circuit to provide power of the battery to each component of the wearable device 100.

In an embodiment, the wearable device 100 may include a sensor module (not shown) (e.g., the sensor module 520 of FIG. 5A) configured to obtain sensor data from at least one sensor. The sensor module may obtain sensor data including motion information of the user and/or motion information of a component of the wearable device 100. For example, the sensor module may include an inertial sensor (e.g., the IMU 135 of FIG. 1 and the inertial sensor 522 of FIG. 5B) configured to measure a motion value of the upper body of the user or a motion value of the waist support frame 20 and an angle sensor (e.g., the angle sensor 125 of FIG. 1, a first angle sensor 524 and a second angle sensor 524-1 of FIG. 5B) configured to measure a hip joint angle value of the user or a motion value of the torque transmission frame 50 or 55, but the example is not limited thereto. For example, the sensor module may further include at least one of a position sensor, a temperature sensor, a biosignal sensor, a distance sensor, or a proximity sensor.

The waist fastener 60 may be directly or indirectly connected to the waist support frame 20 and may fasten the waist support frame 20 to the waist of the user. The waist fastener 60 may include, for example, a pair of belts.

The driving module 35 or 45 may generate an external force (or torque) applied to the body of the user based on the control signal generated by the processor. For example, the driving module 35 or 45 may generate an assistance force or a resistance force applied to the legs of the user. In an embodiment, the driving modules 35 and 45 may include a first driving module 45 disposed at a position corresponding to a right hip joint of the user and a second driving module 35 disposed at a position corresponding to a left hip joint of the user. The first driving module 45 may include a first actuator and a first joint member and the second driving module 35 may include a second actuator and a second joint member. The first actuator may provide power transferred to the first joint member and the second actuator may provide power transferred to the second joint member. The first actuator and the second actuator may each include a motor configured to generate power (or torque) by receiving power from the battery. When the motor is driven as the power is supplied to the motor, the motor may generate a force (an assistance force) for assisting a body motion of the user or a force (a resistance force) for hindering a body motion of the user. In an embodiment, the control module may adjust the strength and direction of the force generated by the motor by adjusting a voltage and/or a current supplied to the motor.

In an embodiment, the first joint member and the second joint member may receive power from the first actuator and the second actuator, respectively, and may apply an external force to the body of the user based on the received power. In an embodiment, the first joint member and the second joint member may be disposed at positions corresponding to joints of the user, respectively. One side of the first joint member may be directly or indirectly connected to the first actuator and the other side of the first joint member may be directly or indirectly connected to the first torque transmission frame 55. The first joint member may be rotated by the power received from the first actuator. An encoder or a hall sensor that may operate as an angle sensor to measure a rotation angle (corresponding to a joint angle of the user) of the first joint member or the first torque transmission frame 55 may disposed on one side of the first joint member. One side of the second joint member may be connected, directly or indirectly, to the second actuator, and the other side of the second joint member may be connected, directly or indirectly, to the second torque transmission frame 50. The second joint member may be rotated by the power received from the second actuator. An encoder or a hall sensor that may operate as an angle sensor to measure a rotation angle of the second joint member or the second torque transmission frame 50 may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, the embodiments are not limited thereto, and an actuator and a joint member may share a rotation axis. In an embodiment, each actuator may be spaced apart from a corresponding joint member. In this case, the driving module 35 or 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, when the wearable device 100 is worn on the user's legs, the first torque transmission frame 55 and the second torque transmission frame 50 may transmit torque generated by the first driving module 45 and the second driving module 35 to the body (e.g., legs) of the user, respectively. The transmitted torque may function as an external force applied to a leg motion of the user. Respective ends of the first torque transmission frame 55 and the second torque transmission frame 50 may be directly or indirectly connected to the joint member and may rotate. As the other ends of the first torque transmission frame 55 and the second torque transmission frame 50 are directly or indirectly connected to the first thigh fastener 2 and the second thigh fastener 1, the first torque transmission frame 55 and the second torque transmission frame 50 may transmit the torque generated by the first driving module 45 and the second driving module 35 to the user's thighs while supporting the user's thighs. For example, the first torque transmission frame 55 and the second torque transmission frame 50 may push or pull the user's thighs. The first torque transmission frame 55 and the second torque transmission frame 50 may extend in a longitudinal direction of the user's thighs or may be bent and enclose at least some portions of the circumferences of the user's thighs. The first torque transmission frame 55 may be a torque transmission frame for transmitting torque to the right leg of the user and the second torque transmission frame 50 may be a torque transmission frame for transmitting torque to the left leg of the user.

The first thigh fastener 2 and the second thigh fastener 1 may be directly or indirectly connected to the first torque transmission frame 55 and the second torque transmission frame 50, respectively, and may fasten the wearable device 100 to the legs (specifically, thighs) of the user. For example, the first thigh fastener 2 may be a thigh fastener for fastening the wearable device 100 to the right thigh of the user and the second thigh fastener 1 may be a thigh fastener for fastening the wearable device 100 to the left thigh of the user.

In an embodiment, the first thigh fastener 2 may include a first cover, a first fastening frame, and a first strap, and the second thigh fastener 1 may include a second cover, a second fastening frame, and a second strap. The first cover and the second cover may apply torques generated by the first driving module 45 and the second driving module 35 to the user's thighs, respectively. For example, the first cover and the second cover may be respectively disposed respective sides of the user's thighs and may push or pull the user's thighs. The first cover and the second cover may be disposed in the circumferential directions of the thighs of the user. The first cover and the second cover may extend to both sides from the other ends of the first torque transmission frame 55 and the second torque transmission frame 50 and may include curved surfaces corresponding to the thighs of the user. The respective ends of the first cover and the second cover may be directly or indirectly connected to the first fastening frame and the second fastening frame. The other ends of the first cover and the second cover may be directly or indirectly connected to the first strap and the second strap.

For example, the first fastening frame and the second fastening frame may be disposed to enclose at least some portions of the circumferences of the user's thighs, thereby the chance of the user's thighs being separated from the wearable device 100 may be reduced, or a possibility of separation may decrease. The first fastening frame may have a fastening structure that connects the first cover to the first strap, and the second fastening frame may have a fastening structure that connects the second cover to the second strap.

The first strap may enclose a remaining portion of the circumference of the right thigh of the user, which is not covered by the first cover and the first fastening frame, and the second strap may enclose a remaining portion of the circumference of the left thigh of the user, which is not covered by the second cover and the second fastening frame. The first strap and the second strap may include, for example, an elastic material (e.g., a band).

FIGS. 5A and 5B are diagrams illustrating a configuration of a control system of a wearable device, according to an embodiment.

Referring to FIG. 5A, a wearable device (e.g., the wearable device 100 of FIGS. 1-4) may be controlled by a control system 500. The control system 500 may include a control module 510 (including a processing circuitry of a processor), a communication module 516 including a communication circuitry, a sensor module 520 including at least one sensor, a driving module 530 including a motor and/or a driver circuitry, an input module 540 including a circuitry, and a sound output module 550. The driving module 530 may include a motor 534 configured to generate power (e.g., torque) and a motor driver circuit 532 configured to drive the motor 534. Although FIG. 5A illustrates the driving module 530 including one motor driver circuit 532 and one motor 534, the example of FIG. 5A is merely an example. Referring to FIG. 5B, in a control system 500-1 as shown in the embodiment of FIG. 5B, a plurality (e.g., two or more) of motor driver circuits 532 and 532-1 and motors 534 and 534-1 may be provided. The driving module 530 including the motor driver circuit 532 and the motor 534 may correspond to the first driving module 45 of FIG. 3 and the driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 shown in FIG. 5B.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Referring back to FIG. 5A, the sensor module 520 may include at least one sensor configured to obtain sensor data. The sensor module 520 may transmit the obtained sensor data to the control module 510 (including a control circuit such as a processing circuit of a processor). The sensor module 520 may include a sensor configured to obtain sensor data including motion information of a user or motion information of a wearable device. The sensor module 520 may include an inertial sensor 522, a first angle sensor 524, and a second angle sensor 524-1 as shown in FIG. 5B. The inertial sensor 522 may measure an upper body motion value of the user. For example, the inertial sensor 522 may sense the acceleration and angular velocity of an X-axis, a Y-axis, and a Z-axis according to motion of the user. In addition, the inertial sensor 522 may obtain a motion value (e.g., an acceleration value and an angular velocity value) of a waist support frame of the wearable device. The first angle sensor 524 and the second angle sensor 524-1 may measure a hip joint angle value according to the leg motion of the user. The first angle sensor 524 may sense a change in the hip joint angle value of the right leg of the user and the second angle sensor 524-1 may sense a change in the hip joint angle value of the left leg of the user. For example, the first angle sensor 524 and the second angle sensor 524-1 may respectively include an encoder and/or a hall sensor. In addition, the first and second angle sensors 524 and 524-1 may obtain a motion value of a torque transmission frame of the wearable device. For example, the first angle sensor 524 may obtain a motion value (e.g., a rotation angle value) of the first torque transmission frame 55 and the second angle sensor 524-1 may obtain a motion value (e.g., a rotation angle value) of the second torque transmission frame 50.

In an embodiment, the sensor module 520 may further include a position sensor configured to obtain a position value of the wearable device, a proximity sensor configured to sense the proximity of an object, a biosignal sensor configured to detect a biosignal of a user, and a temperature sensor configured to measure an ambient temperature.

The input module 540 may receive a command or data to be used by another component (e.g., a processor 512) of the wearable device from the outside (e.g., the user) of the wearable device. The input module 540 may include, for example, a key (e.g., a button) or a touch screen.

The sound output module 550 may output a sound signal to the outside of the wearable device. The sound output module 550 may include a guide sound signal (e.g., a driving start sound or an operation error notification sound) and a speaker for playing music content or a guide voice.

In an embodiment, the control system 500 may include a battery (not shown) to supply power to each component of the wearable device. The wearable device may convert the power of the battery into power suitable for an operating voltage of each component of the wearable device and supply the converted power to each component.

The driving module 530 may generate an external force to be applied to the user's legs by control of the control module 510. The driving module 530 may be in a position corresponding to a position of a hip joint of the user and may generate torque to be applied to the user's legs based on a control signal generated by the control module 510. The control module 510 may transmit the control signal to the motor driver circuit 532, and the motor driver circuit 532 may control an operation of the motor 534 by generating a current signal (or a voltage signal) corresponding to the control signal and supplying the current signal (or the voltage signal) to the motor 534. The current signal may not be supplied to the motor 534 according to the control signal. When the current signal is supplied to the motor 534, and the motor is driven, the motor 534 may generate an assistance force to assist the leg motion of the user or a resistance force to impede the leg motion of the user.

The control module 510 may control an overall operation of the wearable device, and may generate a control signal to control each component of the wearable device. The control module 510 may include a processor 512 and a memory 514.

The processor 512 may execute, for example, software to control at least one other component (e.g., a hardware or software component) of the wearable device directly or indirectly connected to the processor 512, and may perform a variety of data processing or computation. According to an embodiment, as at least a part of data processing or computation, the processor 512 may store instructions or data received from another component (e.g., the communication module 516) in the memory 514, may process the instructions or the data stored in the memory 514, and may store result data in the memory 514. According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of, or in conjunction with the main processor. The auxiliary processor may be implemented separately from the main processor or as a part of the main processor.

The memory 514 may store a variety of data used by at least one component (e.g., the processor 512) of the control module 510. The variety of data may include, for example, software, sensor data, input data or output data for instructions related thereto. The memory 514 may include a volatile memory or a non-volatile memory (e.g., a random-access memory (RAM), a dynamic RAM (DRAM), or a static RAM (SRAM)).

The communication module 516 may support establishing a direct (e.g., wired) communication channel or a wireless communication channel between the control module 510 and another component of the wearable device or an external electronic device (e.g., the electronic device 210 or the other wearable device 220 of FIG. 2), and performing communication via the established communication channel. For example, the communication module 516 may transmit the sensor data obtained by the sensor module 520 to an external electronic device (e.g., the electronic device 210 of FIG. 2) and receive a control signal from the external electronic device. The communication module 516 may include one or more CPs that are operable independently of the processor 512 and that support a direct (e.g., wired) communication or a wireless communication. According to an embodiment, the communication module 516 may include a wireless communication module (e.g., a cellular communication module, a short-range wireless communication module, or a global navigation satellite system (GNSS) communication module), and/or a wired communication module. A corresponding one of these communication modules may communicate with another component of the wearable device and/or an external electronic device via a short-range communication network, such as Bluetooth™, wireless-fidelity (Wi-Fi), an ANT or infrared data association (IrDA), or a long-range communication network, such as a legacy cellular network, a 5G network, a next-generation communication network, the Internet, or a computer network (e.g., a local area network (LAN) or a wide region network (WAN)).

The wearable device in an embodiment may include driving modules 530 and 530-1 including motors 534 and 534-1 configured to generate torque, a torque transmission frame (e.g., the first torque transmission frame 55 and the second torque transmission frame 50 of FIG. 3) configured to transmit the generated torque to a leg of a user, a thigh fastener (e.g., the first thigh fastener 2 and the second thigh fastener 1 of FIG. 3) connected, directly or indirectly, to the torque transmission frame and configured to connect the torque transmission frame to the leg of the user, and a processor 512 configure to control the driving modules 530 and 530-1.

In an embodiment, when the wearable device 100 operates in an exercise mode for assisting the exercise of the user, the processor 512 may determine target exercise speed to achieve a target exercise amount of an exercise program performed by the wearable device based on the ground inclination in a direction in which the wearable device 100 moves. The processor 512 may adjust at least one of the current target exercise speed set to the exercise program and the current exercise intensity set to the exercise program based on the determined target exercise speed. When the exercise intensity is adjusted, a magnitude of the strength provided to the user from the driving module 530 or 530-1 may vary.

In an embodiment, when it is determined that the ground in a direction in which the wearable device 100 moves is upward inclination and a level of the ground inclination is greater than or equal to a first threshold value, the processor 512 may determine the target exercise speed that is lower than the current target exercise speed of the exercise program.

In an embodiment, when it is determined that the ground in a direction in which the wearable device 100 moves is downward inclination and a level of the ground inclination is greater than or equal to a second threshold value, the processor 512 may determine the target exercise speed to be predetermined low or minimum exercise speed set to the exercise program. For example, when the ground is downward inclination and a level of the ground inclination is greater than the second threshold value, the processor 512 may determine that the current ground is steep downward inclination and may execute a safe mode for an operation mode of the wearable device 100. When the safe mode is executed, the current target exercise speed may be adjusted to the predetermined minimum exercise speed. In the safe mode, the processor 512 may decrease strength of torque generated by the motor 534 or 534-1 or may stop generation of the torque.

In an embodiment, when it is determined that the ground in a direction in which the wearable device 100 moves is downward inclination and a level of the ground inclination is included in a threshold range, the processor 512 may determine the target exercise speed that is higher than the current target exercise speed.

In an embodiment, when it is determined that the user ascends or descends stairs based on the ground inclination, the processor 512 may adjust the current target exercise speed set to the exercise program to the predetermined minimum exercise speed and may adjust the current exercise intensity set to the exercise program to “0”. When the exercise intensity is adjusted to “0”, torque may not be generated by the driving module 530 or 530-1 and the user may perform exercise without being provided with an external force by the wearable device 100.

In an embodiment, when the ground is upward inclination and the determined target exercise speed is less than or equal to the predetermined minimum exercise speed, the processor 512 may adjust the current target exercise speed to the minimum exercise speed and may lower the exercise intensity set to the exercise program. The minimum exercise speed may correspond to the target exercise speed having a smallest value set to the exercise program. The strength of the torque generated by the motor 534 or 534-1 may decrease by lowering the exercise intensity. When the ground is downward inclination and the determined target exercise speed is greater than or equal to the predetermined high or maximum exercise speed, the processor 512 may adjust the current target exercise speed to the high or maximum exercise speed and may raise the exercise intensity set to the exercise program. The maximum exercise speed may correspond to the target exercise speed having a highest value set to the exercise program. The strength of the torque generated by the motor 534 or 534-1 may increase by raising the exercise intensity.

In an embodiment, the target exercise speed may be determined by another device (e.g., the electronic device 210 or the server 230 of FIG. 2). A control signal for controlling the wearable device 100 may be transmitted to the wearable device 100 via the communication module 516 based on information about the ground inclination and the target exercise speed from the other device and/or the target exercise speed.

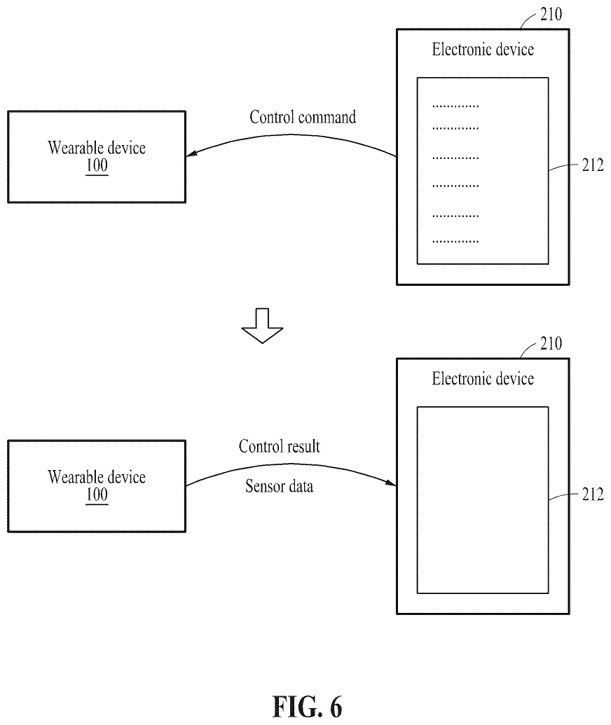

FIG. 6 is a diagram illustrating an interaction between a wearable device and an electronic device according to an embodiment.

Referring to FIG. 6, the wearable device 100 may communicate with the electronic device 210. For example, the electronic device 210 may be a user terminal of a user of the wearable device 100. In an embodiment, the wearable device 100 and the electronic device 210 may be connected to each other via short-range wireless communication (e.g., Bluetooth™ or Wi-Fi communication).

In an embodiment, the electronic device 210 may check a state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a graphical user interface (GUI).

In an embodiment, the user may input an instruction for controlling the operation of the wearable device 100 (e.g., an execution instruction to a walking assistance mode or an exercise assistance mode) or may change settings of the wearable device 100 through a GUI screen on the display 212 of the electronic device 210. The electronic device 210 may generate a control instruction (or control signal) corresponding to an operation control instruction or a setting change instruction input by the user and transmit the generated control instruction to the wearable device 100. The wearable device 100 may operate according to the received control instruction and transmit a control result according to the control instruction and/or sensor data measured by the sensor module of the wearable device 100 to the electronic device 210. The electronic device 210 may provide the user with result information (e.g., current exercise status information, exercise result information, exercise posture assessment information, and physical ability assessment information) derived by analyzing the control result and/or sensor data through the GUI screen.

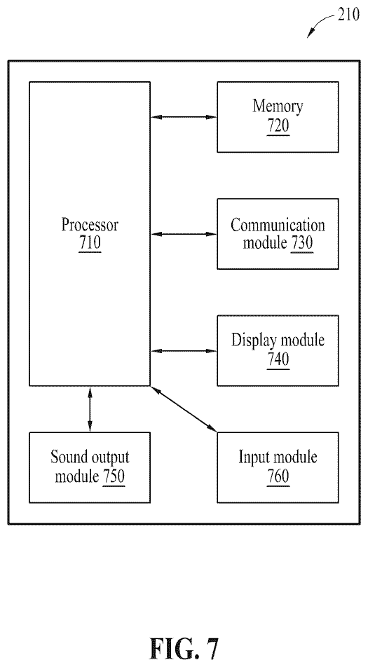

FIG. 7 is a diagram illustrating a configuration of an electronic device according to an embodiment.

Referring to FIG. 7, the electronic device 210 may include a processor 710, a memory 720, a communication module 730, a display module 740, a sound output module 750, and an input module 760. In an embodiment, at least one of the components (e.g., the sound output module 750) may be omitted from the electronic device 210, or one or more other components (e.g., a sensor module, a haptic module, and a battery) may be added to the electronic device 210.

The processor 710 may control at least one other component (e.g., a hardware or software component) of the electronic device 210 and may perform various types of data processing or operations. In an embodiment, as at least a part of data processing or operations, the processor 710 may store instructions or data received from another component (e.g., the communication module 730) in the memory 720, process the instructions or the data stored in the memory 720, and store result data in the memory 720.

In an embodiment, the processor 710 may include a main processor (e.g., a CPU or an AP) or an auxiliary processor (e.g., a GPU, an NPU, an ISP, a sensor hub processor, or a CP) that is operable independently of or in conjunction with the main processor.

The memory 720 may store various pieces of data used by at least one component (e.g., the processor 710 or the communication module 730) of the electronic device 210. The data may include, for example, a program (e.g., an application), and input data or output data for a command related thereto. The memory 720 may include at least one instruction executable by the processor 710. The memory 720 may include, for example, a volatile memory or a non-volatile memory. In this case, each processor may include a processing circuit.

The communication module 730 may support establishing a direct (e.g., wired) communication channel or a wireless communication channel between the electronic device 210 and another electronic device (e.g., the wearable device 100, the other wearable devices 220, and the server 230), and performing communication via the established communication channel. The communication module 730 may include a communication circuit for performing a communication function. The communication module 730 may include one or more CPs that are operable independently of the processor 710 (e.g., an AP) and that support a direct (e.g., wired) communication or a wireless communication. In an embodiment, the communication module 730 may include a wireless communication module (e.g., a Bluetooth™ communication module, a cellular communication module, a Wi-Fi communication module, or a GNSS communication module) that performs wireless communication or a wired communication module (e.g., a LAN communication module or a power line communication (PLC) module). For example, the communication module 730 may transmit a control instruction to the wearable device 100 and receive, from the wearable device 100, at least one of sensor data including body motion information of the user who is wearing the wearable device 100, state data of the wearable device 100, or control result data corresponding to the control instruction.

The display module 740 may visually provide information to the outside (e.g., the user) of the electronic device 210. The display module 740 may include, for example, a light-emitting diode (LCD) or organic light-emitting diode (OLED) display, a hologram device, or a projector device. The display module 740 may further include a control circuit to control the driving of the display. In an embodiment, the display module 740 may further include a touch sensor set to sense a touch or a pressure sensor set to sense the intensity of a force generated by the touch. The display module 740 may output a UI screen to control the wearable device 100 or provide various pieces of information (e.g., exercise evaluation information or setting information of the wearable device 100).

The sound output module 750 may output a sound signal to the outside of the electronic device 210. The sound output module 750 may include a speaker configured to play back a guiding sound signal (e.g., an operation start sound or an operation error alarm), music content, or a guiding voice based on the state of the wearable device 100. For example, when it is determined that the wearable device 100 is not normally worn on the body of the user, the sound output module 750 may output a guiding voice for notifying the user of abnormal wearing of the wearable device 100 or guiding the user to wear the wearable device 100 normally.

The input module 760 may receive a command or data to be used by a component (e.g., the processor 710) of the electronic device 210, from the outside (e.g., the user) of the electronic device 210. The input module 760 may include an input component circuit and receive a user input. The input module 760 may include, for example, a touch recognition circuit for recognizing a touch on a key (e.g., a button) and/or a screen.

When the wearable device 100 operates in an exercise mode for assisting exercise of the user, the electronic device 210 in an embodiment may adjust an attribute value applied to the exercise program based on the ground inclination in a direction in which the wearable device 100 moves. For example, the electronic device 210 may adjust the current target exercise speed and/or the exercise intensity of the exercise program based on the ground inclination.

The electronic device 210 in an embodiment may include the processor 710 and the communication module 730 configured to communicate with the wearable device 100 under control of the processor 710. When the wearable device 100 operates in an exercise mode for assisting the exercise of the user, the processor 710 may determine target exercise speed to achieve a target exercise amount of an exercise program performed by the wearable device 100 based on the ground inclination in a direction in which the wearable device 100 moves. The processor 710 may adjust at least one of the current target exercise speed of the wearable device 100 and the exercise intensity currently set to the wearable device 100 based on the determined exercise speed.

In an embodiment, when it is determined that the ground in a direction in which the wearable device 100 moves is upward inclination and a level of the ground inclination is greater than or equal to a first threshold value, the processor 710 may determine the target exercise speed that is lower than the current target exercise speed of the exercise program. When the ground in a direction in which the wearable device 100 moves is upward inclination and the determined target exercise speed is less than or equal to the predetermined minimum exercise speed, the processor 710 may adjust the current target exercise speed to the minimum exercise speed and may raise the exercise intensity set to the exercise program. When the exercise intensity is lowered, the processor 710 may generate a control signal to increase the strength of the torque generated by the wearable device 100. The generated control signal may be transmitted to the wearable device 100 through the communication module 730 and the wearable device 100 may increase the strength of the torque generated by a motor (e.g., the motor 534 or 534-1 of FIG. 5B) in response to the reception of the control signal.

In an embodiment, when it is determined that the ground in a direction in which the wearable device 100 moves is downward inclination and a level of the ground inclination is included in a threshold range, the processor 710 may determine the target exercise speed that is higher than the current target exercise speed. When the user performs walking exercise on a downhill road, a force may be less consumed than when performs the walking exercise on a flat road. Accordingly, when performing the walking exercise at the same exercise speed, an exercise amount achieved during the walking exercise on the downhill road may be less than an exercise amount achieved while the user performs the walking exercise at the same speed on the flat road. The processor 710 may increase the target exercise speed on the downhill road of the ground inclination included in the threshold range to achieve the planned target exercise amount.

In an embodiment, when the ground in a direction in which the wearable device 100 moves is downward inclination and the determined target exercise speed is greater than or equal to predetermined maximum exercise speed, the processor 710 may adjust the current target exercise speed to the maximum exercise speed and may raise the exercise intensity set to the exercise program. When the exercise intensity increases, the processor 710 may generate a control signal to increase the strength of the torque generated by the wearable device 100. The generated control signal may be transmitted to the wearable device 100 through the communication module 730 and the wearable device 100 may increase the strength of the torque generated by a motor (e.g., the motor 534 or 534-1 of FIG. 5B) in response to the reception of the control signal.

In an embodiment, when it is determined that the ground in a direction in which the wearable device 100 moves is downward inclination and a level of the ground inclination is greater than or equal to a second threshold value, the processor 710 may determine the target exercise speed to be predetermined minimum exercise speed set to the exercise program. When the ground is downward inclination and a level of the ground inclination is greater than or equal to the second threshold value, the processor 710 may determine that the current ground is steep downward inclination and may generate a control signal to control the wearable device 100 to be operated in a safe mode. The generated control signal may be transmitted to the wearable device 100 through the communication module 516/730 (which comprises communication circuitry) and the wearable device 100 may adjust the current target exercise speed to the predetermined minimum exercise speed in response to the reception of the control signal. When the safe mode is enabled, the wearable device 100 may decrease the torque magnitude or may not generate torque in addition to the adjustment of the target exercise speed.

In an embodiment, when it is determined that the user ascends or descends stairs based on the ground inclination, the processor 710 may adjust the current target exercise speed set to the exercise program to the predetermined minimum exercise speed and may adjust the current exercise intensity set to the exercise program to “0”. When the exercise intensity is adjusted to “O”, torque may not be generated by the wearable device 100 and the user may perform exercise without being provided with an external force by the wearable device 100.

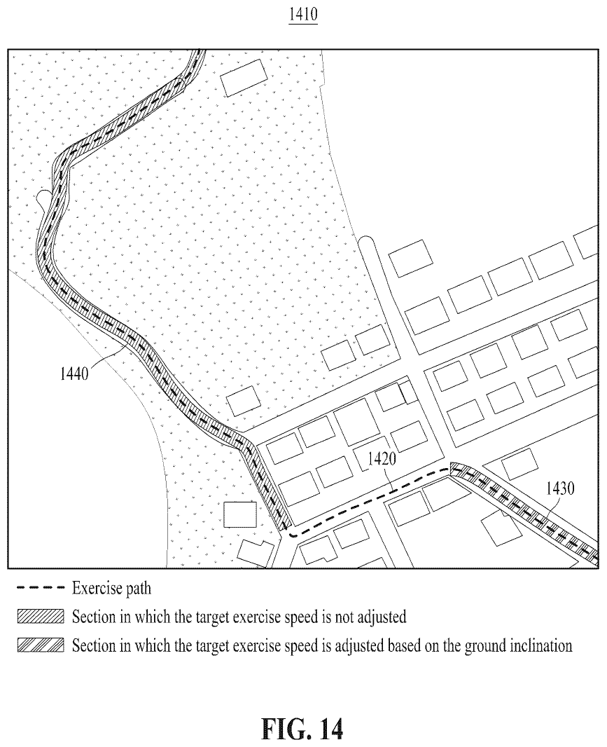

In an embodiment, the display module 740 may include a display that provides map data (e.g., map data 1410 of FIG. 14) showing an exercise path of a user according to the performance of the exercise program and a section in which the target exercise speed is adjusted based on the ground inclination. The display module 740 may show an exercise path in which the user moves during the exercise program on the map data. The display module 740 may provide the user by showing a session in which the ground inclination exists in the exercise path of the user and a session in which the user performs the exercise without the adjustment of the target exercise speed on the map data.

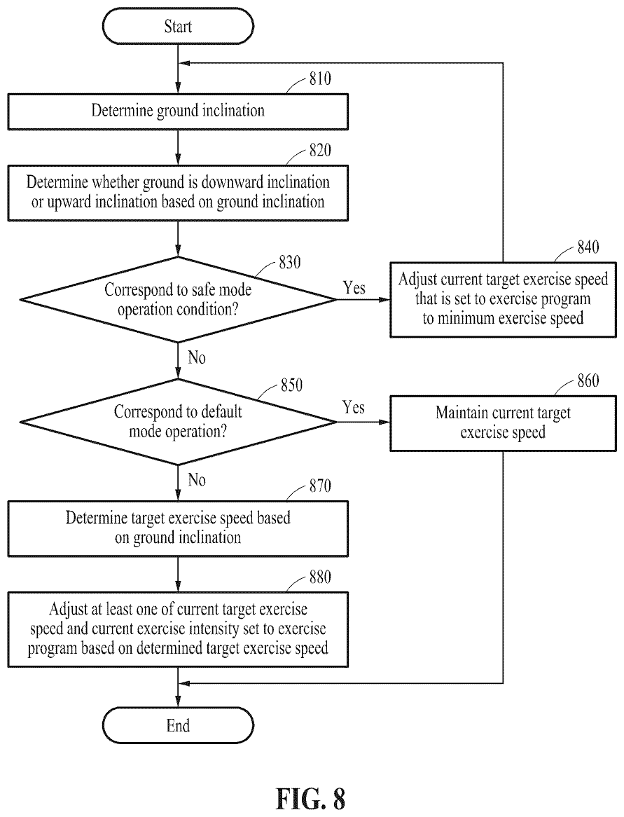

FIG. 8 is a flowchart illustrating operations of an exercise assistance method of assisting exercise of a user based on ground inclination according to an embodiment. In an embodiment, at least one of operations of FIG. 8 may be simultaneously or parallelly performed with one another, and the order of the operations may be changed. In addition, at least one of the operations may be omitted, or another operation may be additionally performed.

Referring to FIG. 8, in operation 810, ground inclination in a direction in which the wearable device 100 that the user wears moves (corresponding to a direction in which a user moves) may be determined based on sensor data. In an embodiment, the ground inclination may be a percentage representing a tangent value of a degree of the ground inclination based on flat ground. For example, 100% of a level of the ground inclination may correspond to 45 degrees of the ground inclination. The higher the ground inclination and the faster the walking speed, the user may consume more energy during the walking exercise.

The ground inclination may be measured or determined by various entities.

In an embodiment, when the electronic device 210 and/or the smartwatch 224 determines the ground inclination, the electronic device 210 and/or the smartwatch 224 may determine the ground inclination based on map data showing sensor data measured by a sensor included in the electronic device 210 and/or topographic information of the ground. For example, the sensor may include a position sensor (e.g., a global positioning system (GPS) sensor) configured to measure a position of the user, an inertial sensor configured to measure motion of the user, a pressure sensor configured to measure pressure of a position where the user is located, and a geomagnetic sensor configured to measure a direction in which the user is oriented. In an embodiment, the electronic device 210 and/or the smartwatch 224 may estimate a surrounding topographic shape of a position where the user is located based on the position of the user measured by the position sensor and the map data and may estimate the direction in which the user is oriented through the geomagnetic sensor. The electronic device 210 and/or the smartwatch 224 may estimate the ground inclination in a direction in which the user moves at the position of the user based on an estimation result. In an embodiment, the electronic device 210 and/or the smartwatch 224 may estimate a change in elevation (corresponding to an inclination angle of the ground) compared to a moving distance based on a moving distance measured by an inertial sensor (or a position sensor) when the user performs walking exercise and a change in pressure measured by the pressure sensor when moving the moving distance, and may estimate the ground inclination based on the estimation result.

In an embodiment, when the wearable device 100 determines the ground inclination, the wearable device 100 may estimate a walking pattern of the user based on motion information of the user measured through a sensor (e.g., the inertial sensor 522, the first angle sensor 524, and the second angle sensor 524-1 of FIG. 5B) and may estimate the ground inclination based on the estimated walking pattern. The wearable device 100 may determine information about the ground inclination based on an angle difference between an angle of the first torque transmission frame (corresponding to a hip joint angle of a right leg of the user) and an angle of the second torque transmission frame (corresponding to a hip joint angle of a left leg of the user) and a time point when a foot of the user contacts the ground through a gait cycle analysis of the user. The information about the ground inclination may include a ground inclination attribute (e.g., whether the ground is upward inclination, downward inclination, flat ground, or stairs) and the ground inclination. The information about the ground inclination determined by the wearable device 100 may be transmitted to the electronic device 210.

In an embodiment, the ground inclination may be determined using the smartglasses 226 provided with a vision sensor. Point cloud data showing a shape of the topography in a forward direction in which the user moves may be obtained and the smartglasses 226 may estimate the ground inclination in the forward direction of the user based on the point cloud data. The smartglasses 226 may recognize the flat ground in the point cloud data and may estimate the ground inclination of the forward topography based on the recognized flat ground. The information about the estimated ground inclination may be transmitted to the electronic device 210. Alternatively, the point cloud data obtained by the smartglasses 226 may be transmitted to the electronic device 210 and the electronic device 210 may estimate the ground inclination based on the point cloud data.

In operation 820, the electronic device 210 may determine whether the ground is downward inclination or upward inclination in a direction in which the wearable device 100 moves based on the ground inclination. When the ground inclination is determined based on the tangent value of a degree formed between the ground surface and the flat ground, the ground inclination may have a positive value if the ground inclination is the upward inclination and if the ground inclination is the downward inclination, the ground inclination may have a negative value. The electronic device 210 may determine that the ground is the upward inclination when a sign of the ground inclination is positive, and when the sign of the ground inclination is negative, the electronic device 210 may determine that the ground is downward inclination.

In operation 830, the electronic device 210 may determine whether a safe mode operating condition is satisfied based on the ground inclination. When it is determined that the ground is the downward inclination and a level of the ground inclination is greater than a threshold value, the electronic device 210 may determine that the safe mode operating condition is satisfied. For example, when the ground is the downward inclination and the level of the ground inclination is greater than 30% (e.g., when the ground inclination is-35%), the electronic device 210 may determine that the ground is steep downward inclination and may enable the safe mode. When the ground is not downward inclination or the level of the ground inclination is less than 30%, it may be determined that the safe mode operating condition is not satisfied.

When the ground inclination satisfies the safe mode operating condition (“yes” in operation 830), the electronic device 210 may operate the wearable device 100 in the safe mode for safe walking by the user. In operation 840, when it is determined that the ground is downward inclination and the safe mode operating condition is satisfied as the level of the ground inclination is greater than the threshold value, the electronic device 210 may adjust the current target exercise speed set to the exercise program to the predetermined minimum exercise speed. When the safe mode is enabled, the electronic device 210 may lower the current exercise intensity set to the exercise program or may adjust the current exercise intensity to reference exercise intensity (e.g., the predetermined exercise intensity or “0”). When the reference exercise intensity is “0”, torque may not be generated by the wearable device 100.

When the ground inclination does not satisfy the safe mode operating condition (“no” in operation 830), the electronic device 210 may determine whether a default mode operating condition is satisfied at 850. When the ground inclination is 0 or the sign of the ground inclination has a positive or negative value but the ground inclination is included in a specific range (e.g., a range between −5% and +5%), the electronic device 210 may determine that the default mode operating condition is satisfied. The default mode may be applied to a session in which the target exercise speed and/or exercise intensity does not need to be adjusted since the level of the ground inclination is not significant.

When the ground inclination satisfies the default mode operating condition (“yes” in operation 850), the electronic device 210 may maintain the current target exercise speed without adjustment of the target exercise speed in operation 860. The current exercise intensity applied to the wearable device 100 may be maintained without adjustment.

In an embodiment, at least one of operations 830 to 850 may be omitted. For example, after determining whether the ground inclination is downward inclination or upward inclination in operation 820, the target exercise speed may be determined based on the ground inclination in operation 870.

When the ground inclination does not satisfy the default mode operating condition (“no” in operation 850), in operation 870, the electronic device 210 may determine the target exercise speed based on the ground inclination. In an embodiment, when it is determined that the ground is downward inclination or upward inclination, the electronic device 210 may determine the target exercise speed to achieve the target exercise amount of the exercise program performed in the wearable device based on the ground inclination.

In an embodiment, the electronic device 210 may determine whether to enable an uphill mode or a downhill mode based on the sign of the ground inclination and the level of the ground inclination. When it is determined that the ground is upward inclination and the level of the ground inclination is greater than or equal to a first threshold value, the uphill mode may be enabled. When the sign of the ground inclination is positive and the level of the ground inclination is greater than a specific value, the electronic device 210 may determine to enable the uphill mode. For example, when the ground inclination is greater than or equal to +5% (e.g., +5%, +6%, . . . ), it may be determined to enable the uphill mode. In the uphill mode, the electronic device 210 may determine the target exercise speed having a value that is less than the current exercise speed of the exercise program.

In an embodiment, when the sign of the ground inclination is negative and the level of the ground inclination is included in a specific range, the electronic device 210 may determine to enable the downhill mode. When it is determined that the ground in a direction in which the wearable device 100 moves is downward inclination and the level of the ground inclination is included in a threshold range, the electronic device 210 may determine to enable the downhill mode. For example, when the ground inclination is included in a range between −5% and −30%, it may be determined to enable the downhill mode. In the downhill mode, the electronic device 210 may determine the target exercise speed having a value that is greater than the current exercise speed of the exercise program. In an embodiment, when the downhill mode is enabled, the target exercise speed may be differently adjusted depending on the exercise session of the exercise program. For example, during an intensive exercise session, the target exercise speed may be adjusted to be high to maintain or strengthen an exercise effect and during a recovery session, the current target exercise speed may be maintained without adjustment of the target exercise speed to recover the physical strength of the user.

In an embodiment, the target exercise speed may be determined based on an assumption that increasing the ground inclination by 5% (approximately 3 degrees) generates the same exercise amount as an increase in the exercise speed of 1 to 1.5 km/h. Under the assumption, for example, the exercise amount of walking on a road of which the ground inclination is 5% at the exercise speed of 4.5 km/h may be the same as the exercise amount of walking on a road of which the ground inclination is 0% (the flat ground) at the exercise speed of 5.5 km/h. Under the assumption, for example, the exercise amount of walking on a road of which the ground inclination is 10% at the exercise speed of 4.5 km/h may be the same as the exercise amount of walking on a road of which the ground inclination is 0% (the flat ground) at the exercise speed of 6.5 km/h. In the case of upward inclination, the electronic device 210 may assist to achieve the planned target exercise amount by decreasing the target exercise speed to compensate for the exercise amount increased by the ground inclination. For example, when it is determined that the ground inclination of the ground on which the walking exercise is performed is 5% whereas the target exercise speed of a current session set to the exercise program is 5.5 km/h, the target exercise speed during the current session may be determined to be 4 km/h that generates the same exercise amount as walking at the target exercise speed of 5.5 km/h on the flat ground.

In an embodiment, when the ground inclination is greater than or equal to 5%, it may be determined to change the target exercise speed. When it is determined to change the target exercise speed, for example, new target exercise speed may be calculated by decreasing or increasing the previous target exercise speed by 0.2 km/h per ground inclination of #1%. For example, when the previous target exercise speed is 5 km/h, the new target exercise speed may be determined to be 4 km/h if the current ground inclination is 5% (upward inclination) and the new target exercise speed may be determined to be 3 km/h if the current ground inclination is 10%. When the previous target exercise speed is 5 km/h, the new target exercise speed may be determined to be 6 km/h if the current ground inclination is −5% (downward inclination) and the new target exercise speed may be determined to be 7 km/h if the current ground inclination is −10%. When the new determined target exercise speed is less than minimum exercise speed set to the exercise program, the new target exercise speed may be determined to be the minimum exercise speed. When the target exercise speed is lowered in proportion to the ground inclination on the uphill road, an exercise effect may be barely noticeable. For example, walking at the exercise speed of 2 km/h may drop the exercise effect in spite of the ground inclination and adjustment may be required to prevent or reduce a chance of the target exercise speed from being dropped below a specific level for the exercise effect. When the new determined target exercise speed is greater than maximum exercise speed set to the exercise program, the new target exercise speed may be determined to be the maximum exercise speed. When the target exercise speed increases in proportion to the ground inclination on a downhill road, a safety issue, such as falling, may occur, and thus, adjustment may be required to prevent or reduce chances of the target exercise speed from increasing beyond a specific level.

In operation 880, the electronic device 210 may adjust at least one of the current target exercise speed set to the exercise program and the current exercise intensity set to the exercise program based on the target exercise speed determined in operation 870. The electronic device 210 may change the current target exercise speed set to the exercise program to the target exercise speed determined in operation 870.

When the determined target exercise speed is not included in an appropriate target exercise speed range (e.g., when the determined target exercise speed is too fast or too slow), the electronic device 100 may adjust the current target exercise speed as well as the currently applied exercise intensity to achieve an exercise amount (or an exercise effect) targeted in the exercise program. For example, when the target exercise speed reaches the minimum exercise speed or the maximum exercise speed set to the exercise program, a process of adjustment of the exercise intensity may be performed. Based on the adjustment of the exercise intensity, a magnitude of the strength provided by the wearable device 100 to the user may vary.

In an embodiment, when the ground is upward inclination and the target exercise speed determined in operation 870 is less than or equal to the predetermined minimum exercise speed, the electronic device 210 may adjust the current target exercise speed to the minimum exercise speed and may lower the exercise intensity set to the exercise program. When the current target exercise speed is decreased to the minimum exercise speed as the target exercise speed is adjusted by the ground inclination but it is determined that an exercise amount may be achieved more than the planned exercise amount due to the minimum exercise speed, the electronic device 210 may decrease the magnitude of a resistance force output by the wearable device 100 by lowering the exercise intensity. The current target exercise speed may not be adjusted to a value that is less than the minimum exercise speed, thereby, adjustment of the target exercise speed to the minimum exercise speed may result in the achievement of an exercise amount more than the planned exercise amount. In this case, lowering the exercise intensity may compensate for the excess of an exercise amount according to the adjustment of the target exercise speed. For example, when the ground inclination of an uphill road is 17% and an additional exercise amount achieved by the ground inclination of 12% is offset by adjusting the current target exercise speed to the minimum exercise speed, an additional exercise amount achieved by the remaining ground inclination of 5% may be offset by lowering the exercise intensity. Due to the adjustment of the target exercise speed and the exercise intensity, the user may perform an appropriate exercise amount on an uphill road.

In an embodiment, when the ground is downward inclination and the target exercise speed determined in operation 870 is greater than or equal to the predetermined maximum exercise speed, the electronic device 210 may adjust the current target exercise speed to the maximum exercise speed and may increase the exercise intensity set to the exercise program. When the current target exercise speed is increased to the maximum exercise speed as the target exercise speed is adjusted by the ground inclination but it is determined that an exercise amount may be achieved less than the planned exercise amount due to the maximum exercise speed, the electronic device 210 may increase the magnitude of a resistance force output by the wearable device 100 by increasing the exercise intensity. The current target exercise speed may not be adjusted to a value that is greater than the maximum exercise speed, thereby, adjustment of the target exercise speed to the maximum exercise speed may result in the achievement of an exercise amount less than the planned exercise amount. In this case, increasing the exercise intensity may compensate for the lack of an exercise amount according to the adjustment of the target exercise speed. For example, when the ground inclination of a downhill road is −17% and the lack of an exercise amount achieved by the ground inclination of −12% is compensated by adjusting the current target exercise speed to the maximum exercise speed, the lack of an exercise amount achieved by the remaining ground inclination of 5% may be compensated by increasing the exercise intensity. Due to the adjustment of the target exercise speed and the exercise intensity, the user may perform an appropriate exercise amount on a downhill road.

The electronic device 210 may decrease a significant change in an exercise amount performed by the user according to the ground inclination and may provide the user with appropriate exercise intensity according to the ground inclination by compensating for a change in an achieved exercise amount caused by the adjustment of the target exercise speed through the adjustment of the exercise intensity. The adjusted target exercise speed and/or the adjusted exercise intensity may be guided to the user and the user may perform exercise based on the adjusted target exercise speed. For example, a guide voice or a guide screen may be provided to the user to inform the user of the adjustment of the target exercise speed and/or the exercise intensity through wireless earphones (e.g., the wireless earphones 222 of FIG. 2) and/or a smartwatch (e.g., the smartwatch 224 of FIG. 2) connected to the electronic device 210.

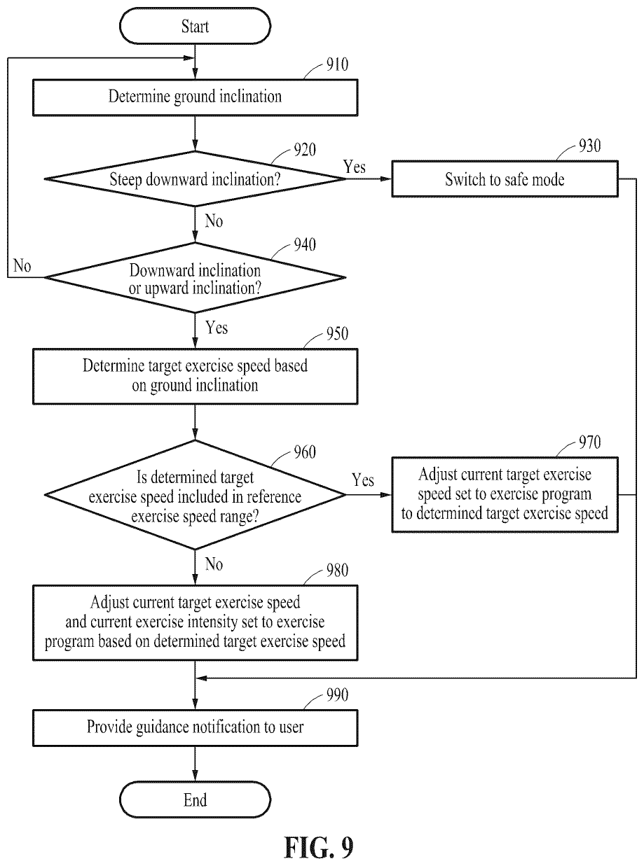

FIG. 9 is a flowchart illustrating operations of an exercise assistance method of assisting exercise of a user based on ground inclination according to an embodiment. In an embodiment, at least one of the operations of FIG. 9 may be simultaneously or parallelly performed with one another, and the order of the operations may be changed. In addition, at least one of the operations may be omitted, or another operation may be additionally performed. Referring to FIG. 9, in operation 910, ground inclination in a direction, in which the wearable device 100 worn by the user moves, may be determined based on sensor data. Operation 910 may correspond to operation 810 of FIG. 8 and any repeated description related thereto is omitted.

In operation 920, the electronic device 210 may determine whether the current ground is steep downward inclination based on ground inclination. For example, when an attribute of the ground inclination is downward inclination and a level of the ground inclination is greater than or equal to a first threshold value, the electronic device 210 may determine that the current ground is steep downward inclination. When it is determined that the current ground is steep downward inclination (“yes” in operation 920), in operation 930, the electronic device 210 may switch an operation mode of the wearable device 100 to a safe mode. When operating in the safe mode, the wearable device 100 may adjust target exercise speed of an exercise mode to preset minimum exercise speed.

When it is determined that the current ground is not steep downward inclination (“no” in operation 920), in operation 940, the electronic device 210 may determine whether the current ground is downward inclination or upward inclination based on the ground inclination. The electronic device 210 may determine that the ground is the upward inclination when a sign of the ground inclination is positive, and when the sign of the ground inclination is negative, the electronic device 210 may determine that the ground is downward inclination.

When it is determined that the current ground is not downward inclination or upward inclination (“no” in operation 940), the electronic device 210 may maintain the current target exercise speed and may perform the operation of determining the ground inclination again.

When it is determined that the current ground is downward inclination or upward inclination (“yes” in operation 940), in operation 950, the electronic device 210 may determine the target exercise speed based on the ground inclination. For example, on the upward inclination, as the ground inclination increases, the target exercise speed may decrease and on the downward inclination, as the ground inclination decreases, the target exercise speed may increase.

In an embodiment, the electronic device 210 may determine the target exercise speed based on the ground inclination and a current exercise session of the exercise program. For example, when the current exercise session is an intensive exercise session, the target exercise speed may be determined to be high and when the current exercise session is a recovery session, the current target exercise speed may be maintained without adjustment of the target exercise speed.

In operation 960, the electronic device 210 may determine whether the target exercise speed determined in operation 950 is included in a reference exercise speed range. When it is determined that the target exercise speed determined in operation 950 is included in the reference exercise speed range (“yes” in operation 960), in operation 970, the electronic device 210 may adjust the current target exercise speed set to the exercise program to the target exercise speed determined in operation 950. When the target exercise speed determined in operation 950 is included in the preset reference exercise speed range, the electronic device 210 may adjust the target exercise speed to the target exercise speed determined in operation 950 without adjustment of the exercise intensity.

When it is determined that the target exercise speed determined in operation 950 is not included in the reference exercise speed range (“no” in operation 960), in operation 980, the electronic device 210 may adjust the current target exercise speed set to the exercise program and the current exercise intensity based on the target exercise speed determined in operation 950. For example, when the current target exercise speed is less than or equal to the preset minimum exercise speed due to the adjustment of the target exercise speed, the electronic device 210 may adjust the current target exercise speed to the minimum exercise speed and may adjust the current exercise intensity to compensate for an exercise amount. When the current target exercise speed is greater than or equal to the preset maximum exercise speed due to the adjustment of the target exercise speed, the electronic device 210 may adjust the current target exercise speed to the maximum exercise speed to prevent or reduce chances of the exercise of the user from being hard as the target exercise speed is too fast and the may adjust the current exercise intensity to compensate for the exercise amount.

In operation 990, the electronic device 210 may provide the user with a guide notification. In an embodiment, when a ground inclination attribute (e.g., downward inclination, upward inclination, steep downward inclination, and stairs) is sensed based on the ground inclination, the electronic device 210 may control to provide the user with a guide notification of the ground inclination attribute. When the target exercise speed and/or the exercise intensity is adjusted based on the ground inclination, the electronic device 210 may control to provide the user with a guide notification of the adjustment of the target exercise speed and/or the exercise intensity. The guide notification may be provided to the user through, for example, the wearable device 100, the electronic device 210, wireless earphones (e.g., the wireless earphones 222 of FIG. 2), or a smartwatch (e.g., the smartwatch 224 of FIG. 2).

In the embodiments of FIGS. 8 and 9, an entity that determines whether to adjust the target exercise speed and/or the exercise intensity based on the ground inclination may be an entity other than the electronic device 210. For example, operations 820 to 880 may be performed by the wearable device 100 or a server (e.g., the server 230 of FIG. 2). As described above, various entities may determine the ground inclination or obtain sensor data for determining the ground inclination. The entity that determines the ground inclination may be the same as or different from the entity that determines whether to adjust the target exercise speed and/or the exercise intensity.

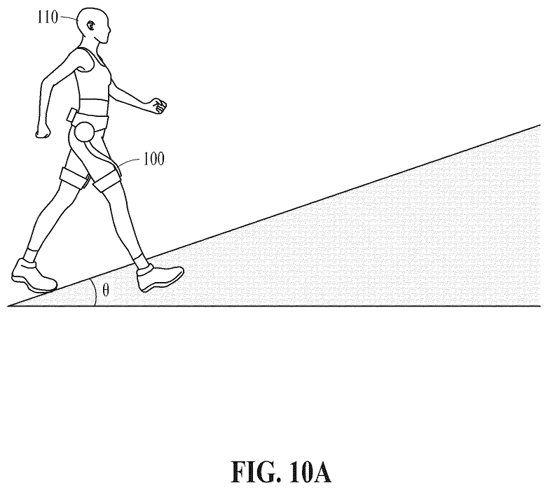

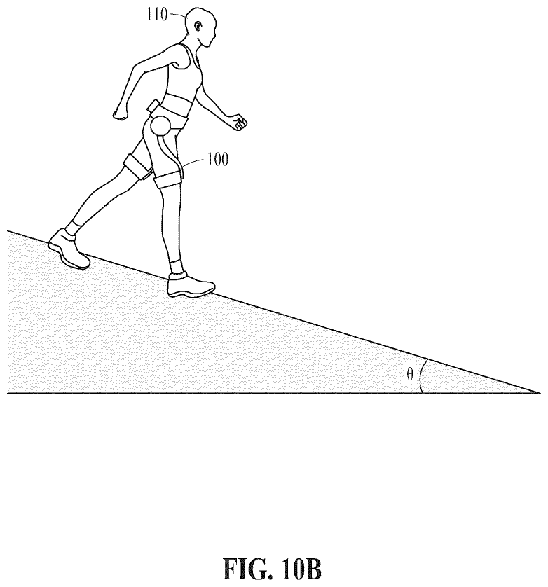

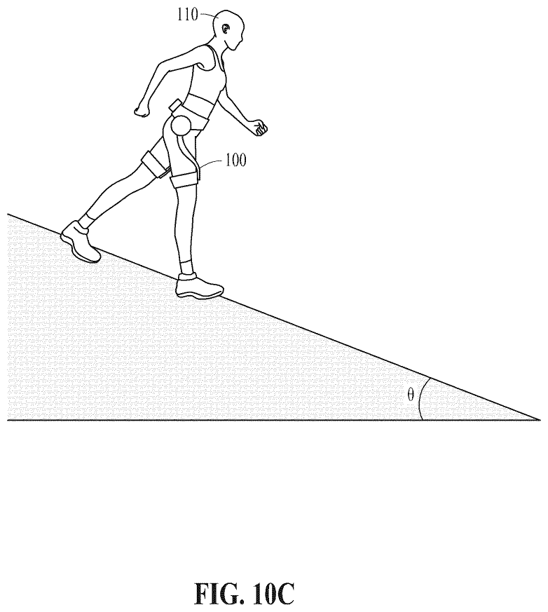

FIGS. 10A, 10B, and 10C are diagrams illustrating adjustment of target exercise speed and/or exercise intensity in different inclination sessions according to an embodiment.

When the user 110 wears the wearable device 100 and performs outdoor walking exercise and the like, the wearable device 100 and/or an electronic device (e.g., the electronic device 210 of FIG. 2) may recognize the ground inclination in a direction in which the user 110 moves (corresponding to a direction in which the wearable device 100 moves), may provide the user 110 with an exercise amount intended by an exercise program by adjusting target exercise speed and/or exercise intensity based on the recognized ground inclination, and may improve the walking safety. In an embodiment, the target exercise speed may be set based on the ground inclination of a road on which the user 110 walks and a current exercise session. After the target exercise speed is set, the exercise intensity may be adjusted based on a change in the exercise amount according to the set target exercise speed.

FIG. 10A illustrates a case in which the user 110 encounters an uphill road during exercise according to an embodiment. In an embodiment, when the user 110 encounters an uphill road during an intensive exercise session or a recovery session, the target exercise speed may be adjusted to low such that the user 110 does not excessively perform exercise compared to a plan by considering an increase in an exercise amount based on the ground inclination. The intensive exercise session may refer to an exercise session operated in a resistance mode in which a resistance force is provided to the user 110 by the wearable device 100 and the recovery session may refer to an exercise session operated in an assistance mode in which an assistance force is provided to the user 110 by the wearable device 100. The user 110 may be guided to achieve an appropriate exercise amount over each time interval during the exercise. When it is expected that the exercise amount may increase more than the planned exercise amount because the exercise is performed on the uphill road, the user 110 may be guided to achieve an appropriate exercise amount on the uphill road. When the target exercise speed adjusted based on the ground inclination reaches the preset minimum exercise speed (e.g., 4.0 km/h), the target exercise speed may not be less than the minimum exercise speed and may be maintained to the minimum exercise speed. Accordingly, the achieved exercise amount may exceed the planned exercise amount and when the target exercise speed reaches the minimum exercise speed, decreasing the exercise intensity may assist the user 110 to achieve an appropriate exercise amount on the uphill road.

In an embodiment, even the upward inclination has the same ground inclination, an adjustment ratio of target exercise speed and/or exercise intensity in the intensive exercise session may be different from an adjustment ratio of target exercise speed and/or exercise intensity in the recovery session. For example, when the target exercise speed is adjusted by the ground inclination, it may be determined to decrease the target exercise speed more in the intensive exercise session than the recovery session and when the exercise intensity is adjusted, it may be determined to lower the exercise intensity more in the recovery session than the intensive exercise session.

FIG. 10B illustrates a case in which the user 110 encounters a downhill road during exercise according to an embodiment. In an embodiment, when the user 110 encounters a downhill road during an intensive exercise session, the target exercise speed may be adjusted to high such that the user 110 is able to achieve a planned exercise amount by considering a decrease in the exercise amount according to the ground inclination. When it is expected that an exercise amount may decrease compared to the planned exercise amount because the exercise is performed on the downhill road, increasing the target exercise speed may induce the user 110 to achieve an appropriate exercise amount on the downhill road. When the target exercise speed adjusted based on the ground inclination reaches the preset maximum exercise speed (e.g., 6.5 km/h), the target exercise speed may not exceed the maximum exercise speed and may be maintained to the maximum exercise speed. Accordingly, the achieved exercise amount may be less the planned exercise amount and when the target exercise speed reaches the maximum exercise speed, increasing the exercise intensity may assist the user 110 to achieve an appropriate exercise amount on the uphill road.

In an embodiment, when the user 110 encounters a downhill road during the recovery session, the target exercise speed may be maintained without adjustment. For example, when an exercise program of interval walking is performed and a downhill road is sensed during the recovery session, the target exercise speed may be maintained without adjustment. In the recovery session, since recovery of the physical strength of the user 110 is required rather than an exercise effect, the target exercise speed may not increase and may be maintained. When the target exercise speed is maintained, the exercise intensity may also be maintained. Alternatively, depending on a type of an exercise program to be performed, when the user 110 encounters a downhill road during the recovery session, the target exercise speed may be adjusted to high. For example, when an exercise program of power walking is performed, since an exercise effect is important, the target exercise speed may be adjusted to high on the downhill road.

FIG. 10C illustrates a case in which the user 110 encounters a steep downhill road during exercise according to an embodiment. When the user 110 encounters a steep downhill road during an intensive exercise session or a recovery session, a safe mode may be operated for the safety of the user 110. For example, when the ground inclination exceeds-30%, the safe mode may be operated. When the safe mode is operated, current target exercise speed may be adjusted to predetermined minimum exercise speed (e.g., 4.0 km/h) and current exercise intensity set to an exercise program may be lowered or may be adjusted to reference exercise intensity. Regardless of types of the exercise program and the exercise session, the current target exercise speed may be adjusted to the minimum exercise speed in the safe mode. When the current exercise intensity is adjusted in the safe mode, the exercise intensity may be phased over time to reduce a possibility of an accident according to rapid adjustment of the exercise intensity.

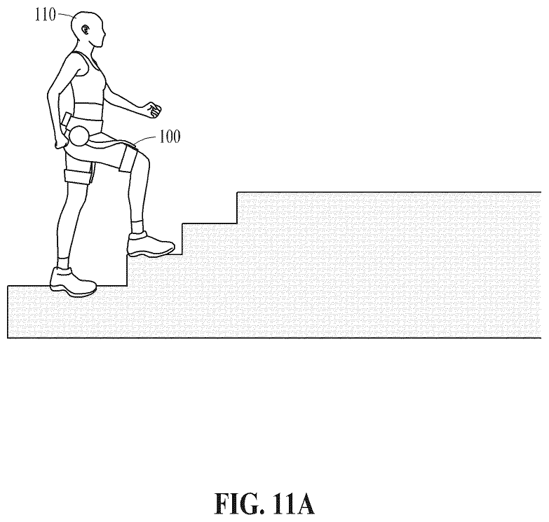

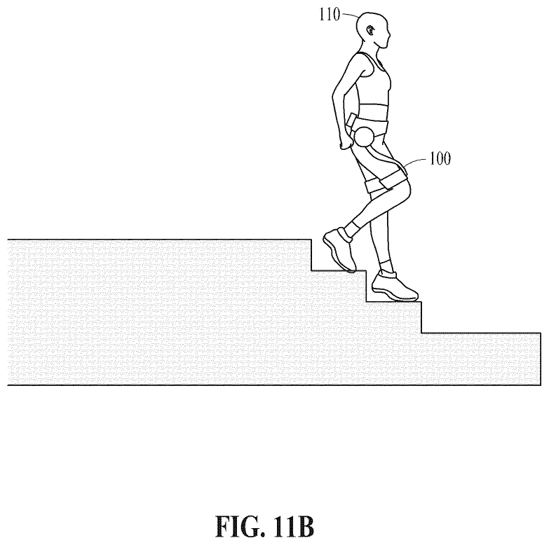

FIGS. 11A and 11B are diagrams illustrating adjustment of target exercise speed and/or exercise intensity in a stair session according to an embodiment.

When the user 110 wears the wearable device 100 and ascends or descends stairs during exercise, the target exercise speed and/or the exercise intensity may be adjusted according to the situation. In the case of stairs, since the ground inclination rapidly increases or decreases, it may be preferable to adjust the target exercise speed and/or the exercise intensity by considering the physical strength and safety of the user 110.

FIG. 11A illustrates an occurrence of a case in which the user 110 ascends stairs according to an embodiment. In an embodiment, when it is determined that the user ascends stairs based on ground inclination during an intensive exercise session or a recovery session, the current target exercise speed may be adjusted to the predetermined minimum exercise speed (e.g., 4 km/h). To prevent or reduce the burden on the exercise of the user 110, when ascending stairs, the current exercise intensity set to the exercise program may be adjusted to “0”. When the current exercise intensity is adjusted to “0”, the user 110 may ascend stairs without being provided with an external force from the wearable device 100 because torque may not be generated by the wearable device 100 (a torque off state).

FIG. 11B illustrates an occurrence of a case in which the user 110 descends stairs according to an embodiment. In an embodiment, when it is determined that the user descends stairs based on ground inclination during an intensive exercise session or a recovery session, the current target exercise speed may be adjusted to the predetermined minimum exercise speed (e.g., 4 km/h). For the safety of the user 110, when descending stairs, the current exercise intensity set to the exercise program may be adjusted to “0” or reference exercise intensity. When the current exercise intensity is adjusted to “0”, the user 110 may descend stairs without being provided with an external force from the wearable device 100. In the case of stairs with steep ground inclination (e.g., stairs of which the ground inclination is greater than −30%), the current exercise intensity may be adjusted to the reference exercise intensity (e.g., preset exercise intensity that is greater than 0). In this case, a resistance force corresponding to the reference exercise intensity may be generated by the wearable device 100 and the user 110 may stably descend stairs based on the resistance force provided from the wearable device 100.

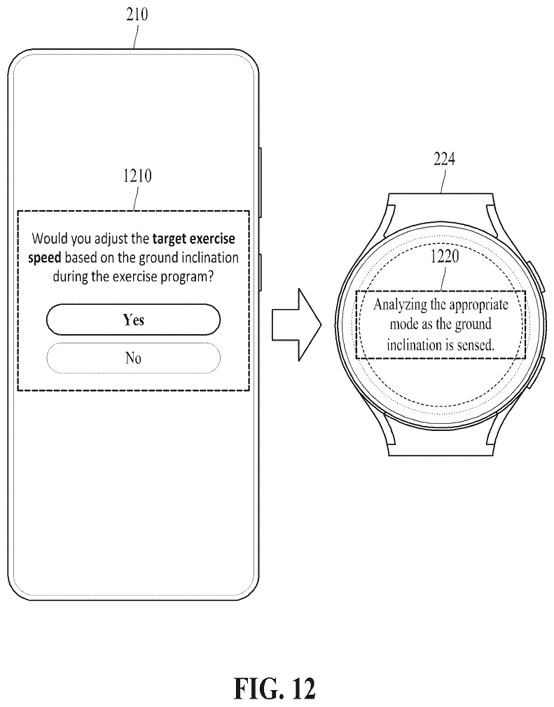

FIG. 12 is a diagram illustrating a user setting screen with respect to adjustment of target exercise speed based on detection of ground inclination according to an embodiment.

Referring to FIG. 12, a user may select an automatic adjustment mode of target exercise speed based on sensing ground inclination through a user setting screen 1210 output through a display module (e.g., the display module 740 of FIG. 7, including a display) of the electronic device 210. Through the settings through the user setting screen 1210, the user may select whether to automatically adjust the target exercise speed set to an exercise program according to the ground inclination when the ground inclination is sensed. When the user executes the automatic adjustment mode of the target exercise speed through the user setting screen 1210 and the ground inclination is sensed during exercise of the user, a guide notification (e.g., a ground inclination sensing notification, an operation mode change notification, a target exercise speed adjustment notification, and an exercise intensity adjustment notification) based on sensing the ground inclination may be provided to the user through the smartwatch 224 or wireless earphones (e.g., the wireless earphones 222 of FIG. 2). For example, a notification message for informing that the ground inclination is sensed and an analysis of whether the current target exercise speed and the exercise intensity set to the exercise program are appropriate based on sensing the ground inclination is performed may be provided through a guide screen 1220 of the smartwatch 224. In an embodiment, a guide voice corresponding to the notification message displayed on the guide screen 1220 may be provided to the user through wireless earphones.

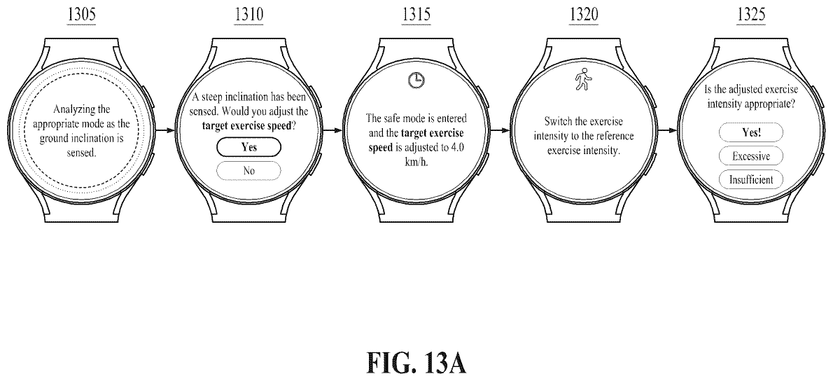

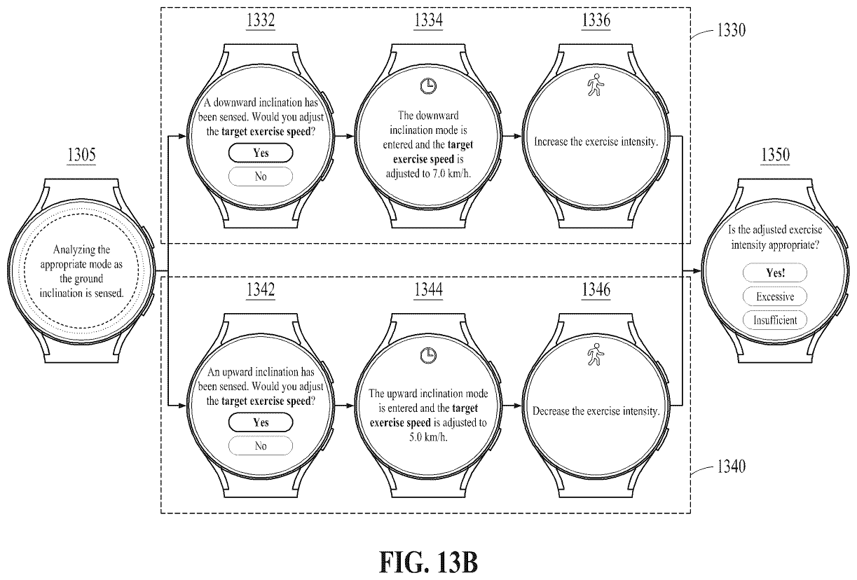

FIGS. 13A and 13B are diagrams illustrating a guide screen displayed on a smartwatch based on an operation mode according to an embodiment.

Referring to FIG. 13A, a series of guide screens 1305, 1310, 1315, 1320, and 1325 displayed on a display of the smartwatch 224 when a safe mode is executed as a result of sensing ground inclination are illustrated. In an embodiment, guide voices corresponding to guide messages displayed on the guide screens 1305, 1310, 1315, 1320, and 1325 may be provided to the user through wireless earphones.

When the ground inclination is sensed, the guide screen 1305 for guiding transition to an appropriate operation mode may be provided. The guide screen 1305 may include a message for guiding that the ground inclination is sensed and an analysis of whether the current target exercise speed and the exercise intensity set to the exercise program based on sensing the ground inclination is performed.

When steep downward inclination is sensed as a result of sensing the ground inclination, the guide screen 1310 for notifying the user that the steep downward inclination is sensed and asking the user whether to adjust the target exercise speed may be provided. When the user selects adjustment of the target exercise speed, the guide screen 1315 for switching to the safe mode based on sensing the steep downward inclination and guiding the changed target exercise speed may be provided. In the safe mode, the exercise intensity may be adjusted to the reference exercise intensity for the walking safety of the user and when the exercise intensity is adjusted, the guide screen 1320 for guiding the adjustment of the exercise intensity may be provided to the user. Thereafter, the guide screen 1325 for asking whether the adjusted exercise intensity is appropriate may be provided to the user and based on the selection of the user, the exercise intensity may be additionally adjusted. Depending on the selection of the user, the current exercise intensity may increase or decrease.

Referring to FIG. 13B, a series of guide screens 1305, 1332, 1334, 1336, 1342, 1344, 1346, and 1350 displayed on a display of the smartwatch 224 when an uphill mode or a downhill mode is executed as a result of sensing ground inclination are illustrated. In an embodiment, guide voices corresponding to guide messages displayed on the guide screens 1305, 1332, 1334, 1336, 1342, 1344, 1346, and 1350 may be provided to the user through wireless earphones. The guide screens 1332, 1334, and 1336 may be the guide screen 1330 provided in the downhill mode and the guide screens 1342, 1344, and 1346 may be the guide screens 1340 provided in the uphill mode.

When the ground inclination is sensed, the guide screen 1305 for guiding that the ground inclination is sensed and an analysis of whether the current target exercise speed and the exercise intensity set to the exercise program based on sensing the ground inclination is performed may be provided.

In an embodiment, when the downhill mode is executed as a result of sensing the ground inclination, the guide screen 1332 for notifying the user that the downward inclination is sensed and asking the user whether to adjust the target exercise speed may be provided. When the user selects adjustment of the target exercise speed, the guide screen 1334 for switching to the downhill mode and guiding the changed target exercise speed may be provided to the user. When it is determined that it is difficult to achieve a targeted exercise amount due to the adjusted target exercise speed, the exercise intensity may also be adjusted. When the exercise intensity is adjusted, the guide screen 1336 for guiding the adjustment of the exercise intensity may be provided to the user.

In an embodiment, when the uphill mode is executed as a result of sensing the ground inclination, the guide screen 1342 for notifying the user that the upward inclination is sensed and asking the user whether to adjust the target exercise speed may be provided. When the user selects adjustment of the target exercise speed, the guide screen 1344 for switching to the uphill mode and guiding the changed target exercise speed may be provided to the user. When it is determined that it is difficult to achieve a targeted exercise amount due to the adjusted target exercise speed, the exercise intensity may also be adjusted. When the exercise intensity is adjusted, the guide screen 1346 for guiding the adjustment of the exercise intensity may be provided to the user.

When the exercise intensity is adjusted in the downhill mode or the uphill mode, the guide screen 1350 for asking whether the adjusted exercise intensity is appropriate may be provided to the user and the exercise intensity may be additionally adjusted based on the selection of the user.

“Based on” as used herein covers based at least on.

FIG. 14 is a diagram illustrating map data showing a session in which target exercise speed is adjusted based on ground inclination according to an embodiment.

Referring to FIG. 14, an exercise path 1420 in which a user wears the wearable device 100 and performs outdoor walking exercise may be displayed on map data 1410. In an embodiment, the map data 1410 may be provided to the user through a display of the electronic device 210 or the smartwatch 224.

During the outdoor exercise of the user, the ground inclination may be recognized and based on the recognized ground inclination, the target exercise speed may be adjusted to achieve a target exercise amount aimed by an exercise program. The exercise path 1420 of the user according to the performance of the exercise program, a section 1430 in which the ground inclination is recognized but the target exercise speed is not adjusted in the exercise path 1420, and a section 1440 in which the target exercise speed is adjusted based on the ground inclination in the exercise path 1420 may be displayed on the map data 1410. Through the map data 1410, the user may effectively recognize the exercise path and the section in which the target exercise speed is adjusted.

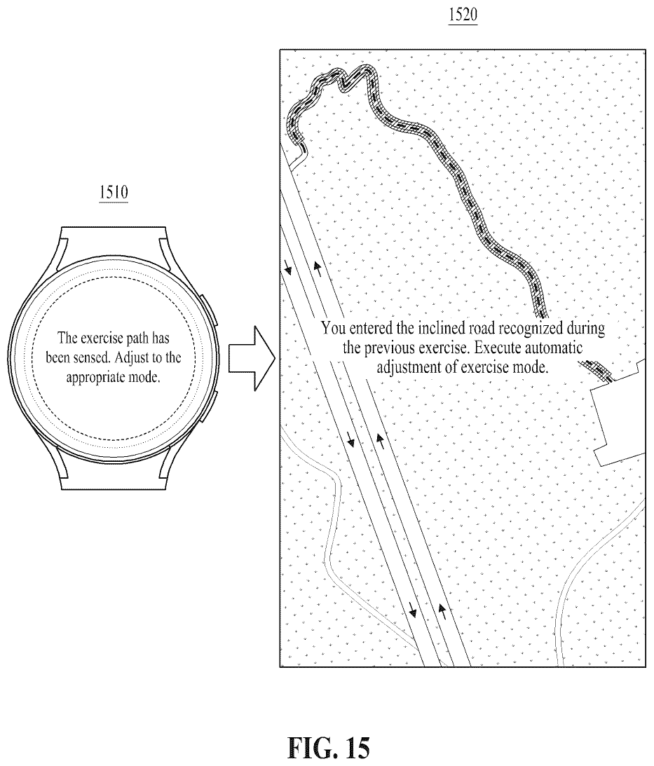

FIG. 15 is a diagram illustrating automatic adjustment of an exercise mode based on detection of a previous exercise path according to an embodiment.

In an embodiment, when the user wears the wearable device 100 and performs exercise, the electronic device 210 may collect an exercise path, ground inclination measured on the exercise path, and an adjustment result of target exercise speed and/or exercise intensity based on the ground inclination. When a current exercise path corresponds to a previous exercise path, a guide screen 1510 for guiding that the current exercise path is the same as the previous exercise path and guiding the transition to an appropriate operation mode may be provided through a smartwatch and the like. Thereafter, automatic adjustment of an exercise mode for automatically adjusting the target exercise speed and/or the exercise intensity in the current exercise path based on the adjustment history of the target exercise speed and/or the exercise intensity in the previous exercise path based on the ground inclination may be executed. When the automatic adjustment of the exercise mode is executed, a guide screen 1520 for guiding that the automatic adjustment of the exercise mode is executed may be provided through a display of the electronic device 210 and/or the smartwatch 224 and the target exercise speed and/or the exercise intensity in the current exercise path may be adjusted the same as the adjustment history in the previous exercise path.

Each embodiment herein may be used in combination with any other embodiment(s) described herein.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “Ist” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Accordingly, each “module” in the present disclosure may include a circuit. Thus, each “module” herein may comprise circuitry.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums. Embodiments as set forth herein may be implemented as software including one or more instructions that are stored in a storage medium (e.g., the memory 514) that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Although the present disclosure exemplifies and describes with reference to various embodiments, it shall be construed that various embodiments are for the illustrative purpose rather than limiting. It shall be further understood by those skilled in the art that various changes in forms and details may be made without departing from the true spirit and full scope of this disclosure including the scope of the attached claims and their equivalents. In addition, it shall be construed that the embodiments described herein may be used with other embodiments of the present disclosure.

What is claimed is:

1. An exercise assistance method for a wearable device based on ground inclination, the method comprising:
determining ground inclination in a direction in which the wearable device worn by the user moves based on sensor data;
determining whether a ground surface in the direction in which the wearable device moves is downward inclination or upward inclination based on the ground inclination;
when the ground surface is the downward inclination or the upward inclination, determining target exercise speed to achieve a target exercise amount of an exercise program based on the ground inclination; and
adjusting at least one of current target exercise speed set to the exercise program and current exercise intensity set to the exercise program, based on the determined target exercise speed.

2. The method of claim 1, wherein the determining of the target exercise speed comprises, when the ground surface is upward inclination and a level of the ground inclination is greater than or equal to a threshold value, determining target exercise speed to have a value that is less than the current target exercise speed of the exercise program.

3. The method of claim 1, wherein the determining of the target exercise speed comprises, when the ground surface in the direction in which the wearable device moves is downward inclination and a level of the ground inclination is comprised in a threshold range, determining target exercise speed to have a value that is greater than the current target exercise speed of the exercise program.

4. The method of claim 1, wherein the adjusting of at least one of the current target exercise speed and the current exercise intensity comprises changing the current target exercise speed set to the exercise program to the determined target exercise speed.

5. The method of claim 1, wherein the adjusting of at least one of the current target exercise speed and the current exercise intensity comprises, when the ground surface is upward inclination and the determined target exercise speed is less than or equal to predetermined low exercise speed, adjusting the current target exercise speed set to the exercise program to a low speed and lowering the exercise intensity set to the exercise program.

6. The method of claim 1, wherein the adjusting of at least one of the current target exercise speed and the current exercise intensity comprises, when the ground surface is downward inclination and the determined target exercise speed is greater than or equal to predetermined high exercise speed, adjusting the current target exercise speed set to the exercise program to the high exercise speed and increasing the exercise intensity set to the exercise program.

7. The method of claim 1, further comprising:
when the ground surface is downward inclination and a level of the ground inclination is greater than a threshold value, adjusting the current target exercise speed set to the exercise program to predetermined low exercise speed.

8. The method of claim 7, further comprising:
when the ground surface is downward inclination and the level of the ground inclination is greater than or equal to the threshold value, lowering the current exercise intensity set to the exercise program and/or adjusting the current exercise intensity to reference exercise intensity.

9. The method of claim 1, wherein a magnitude of a force provided to the user by the wearable device varies depending on adjustment of the exercise intensity.

10. An electronic device comprising:
at least one processor comprising processing circuitry; and
a communication module, comprising communication circuitry, configured to communicate with a wearable device under control of the at least one processor,
wherein the at least one processor is collectively and/or individually configured to:
when the wearable device operates in an exercise mode for assisting exercise of a user, determine target exercise speed to achieve a target exercise amount of an exercise program based on ground inclination in a direction in which the wearable device moves, and
adjust at least one of current target exercise speed of the wearable device and exercise intensity currently set to the wearable device based on the determined target exercise speed.

11. The electronic device of claim 10, wherein the at least one processor is collectively and/or individually configured to, when the ground surface is upward inclination and a level of the ground inclination is greater than or equal to a threshold value, determine target exercise speed to have a value that is less than the current target exercise speed of the exercise program.

12. The electronic device of claim 10, wherein the at least one processor is collectively and/or individually configured to, when the ground surface is upward inclination and the determined target exercise speed is less than or equal to predetermined low exercise speed, adjust the current target exercise speed set to the exercise program to the low exercise speed and lower exercise intensity set to the exercise program.

13. The electronic device of claim 10, wherein the at least one processor is collectively and/or individually configured to, when the ground surface in the direction in which the wearable device moves is downward inclination and a level of the ground inclination is comprised in a threshold range, determine target exercise speed to have a value that is greater than the current target exercise speed of the exercise program.

14. The electronic device of claim 10, wherein the at least one processor is collectively and/or individually configured to, when the ground surface is downward inclination and the determined target exercise speed is greater than or equal to predetermined high exercise speed, adjust the current target exercise speed set to the exercise program to the high exercise speed and increase exercise intensity set to the exercise program.

15. The electronic device of claim 10, wherein the at least one processor is collectively and/or individually configured to, when the ground surface is downward inclination and a level of the ground inclination is greater than a threshold value, adjust the current target exercise speed set to the exercise program to predetermined low exercise speed.

16. The electronic device of claim 10, wherein the at least one processor is collectively and/or individually configured to, when the user ascends or descends stairs based on the ground inclination, adjust the current target exercise speed set to the exercise program to predetermined low exercise speed and adjust the current exercise intensity set to the exercise program to “0”.

17. The electronic device of claim 10, further comprising:
a display module, comprising a display, configured to provide map data showing an exercise path of a user according to performance of the exercise program and a section in which target exercise speed is adjusted based on the ground inclination in the exercise path.

18. A wearable device, comprising:
a driving module, comprising a motor, configured to generate torque;
a torque transmission frame configured to transmit the generated torque to a leg of a user;
a thigh fastener connected to the torque transmission frame and configured to connect the torque transmission frame to the leg of the user; and
at least one processor, comprising processing circuitry, individually and/or collectively configured to:
when the wearable device operates in an exercise mode for assisting exercise of a user, determine target exercise speed to achieve a target exercise amount of an exercise program performed by the wearable device based on ground inclination in a direction in which the wearable device moves, and
adjust at least one of current target exercise speed set to the exercise program and current exercise intensity set to the exercise program based on the determined target exercise speed.

19. The wearable device of claim 18, wherein at least one processor is individually and/or collectively configured to, when the ground surface is upward inclination and the determined target exercise speed is less than or equal to predetermined low exercise speed, adjust the current target exercise speed set to the exercise program to the low exercise speed and lower the exercise intensity set to the exercise program, and
a magnitude of torque generated by the motor decreases by decreasing the exercise intensity.

20. The wearable device of claim 18, wherein at least one processor is individually and/or collectively configured to, when the ground surface is downward inclination and the determined target exercise speed is greater than or equal to predetermined high exercise speed, adjust the current target exercise speed set to the exercise program to the high exercise speed and increase the exercise intensity set to the exercise program, and
a magnitude of torque generated by the motor increases by increasing the exercise intensity.
